(19) United States
(12) Patent Application Publication
(10) Pub. No.: US 2020/0242699 A1
(43) Pub. Date: Jul. 30, 2020

(54) INTEGRATED PERSONAL FINANCE MANAGEMENT SYSTEM FOR MANAGING CASH FLOW

(71) Applicant: Flo Free LLC, Wall, NJ (US)

(72) Inventor: David James Mozeika, Wall, NJ (US)

(21) Appl. No.: 16/846,074

(22) Filed: Apr. 10, 2020

Related U.S. Application Data
(63) Continuation-in-part of application No. 16/103,521, filed on Aug. 14, 2018.
(60) Provisional application No. 62/545,707, filed on Aug. 15, 2017.

(51) Int. Cl. G06Q 40/06; H04L 29/06; G06F 3/0481

(52) U.S. Cl. CPC G06Q 40/06; G06F 3/0481; H04L 63/102

(57) ABSTRACT

This disclosure is directed to computing services that provide consolidated financial data associated with a user, along with metrics that indicate the user's performance in his/her savings. A service system can receive financial account-based information associated with a user and link that information to a user profile of the user. The financial account-based information may be used by the FLO service system to obtain financial transaction data from individual ones of the user's financial accounts. The financial transaction data may then be used to dynamically generate one or more metric values, such as free cash flow, FLO score, indicating the free cash flow as a percentage of cash outflow, and the like. These metric values may be determined dynamically over various time frames and displayed to provide a picture of the user's financial health. The system may also enable interactions with a financial advisor.

### CROSS-REFERENCE TO RELATED APPLICATIONS

This application claims priority to U.S. Provisional Application No. 62/831,498 filed Apr. 9, 2019, the contents of which are incorporated herein, in its entirety, by reference. This application is also a Continuation-in Part of co-pending U.S. patent application Ser. No. 16/103,521, filed Aug. 18, 2018, which claims the benefit of U.S. Provisional Application No. 62/545,707 filed Aug. 15, 2017, the contents of which are both incorporated herein, in their entirety, by reference.

### BACKGROUND

Many people do not save a sufficient amount of money to meet long-term financial goals such as home ownership, college education, retirement, or the like. Oftentimes people may have different financial accounts spread across multiple financial institutions where there may be inflows and outflows of money. However, it may be difficult for people to get a holistic sense of their income, spending, and saving across all of their accounts. Furthermore, many people may find it daunting to synthesize all of the financial data that is available to them. As people have more electronic accounts, such as electronic bank accounts, brokerage accounts, credit card accounts, and the like, it has become increasingly difficult, from a personal finance perspective, to set savings goals, track those goals, and understand how one is performing on a continuous basis in meeting their savings goals.

People's performance in their savings, or a lack thereof, may necessitate a new paradigm in how to track and encourage savings. Traditional mechanisms of tracking savings, such as by a percentage of income or by predetermining a savings amount, may be ineffective in tracking and encouraging savings. Instead, other metrics that effectively tracks one's savings performance over time and encourages the maximization of their savings to be more in line with their future needs may be desirable.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative environment that includes services and systems to enable tracking cash flow and savings performances by users, and/or their financial advisors, according to examples of the disclosure.

FIG. 2 is a block diagram of an illustrative computing architecture of a FLO service system for aggregating financial data and providing financial tracking and savings oriented metrics, as shown in FIG. 1, according to examples of the disclosure.

FIG. 3 is a block diagram of an illustrative computing architecture of a client device for interacting with the FLO service system(s), as shown in FIG. 1, according to examples of the disclosure.

FIG. 4 is a block diagram of an illustrative computing architecture of a financial advisor system for interacting with user financial data, as shown in FIG. 1, according to examples of the disclosure.

FIG. 5 is a flow diagram of an illustrative method to display one or more metrics associated with a user's aggregate reservoir, according to examples of the disclosure.

FIG. 6 is a flow diagram of an illustrative method to determine one or more metrics associated with a user's aggregate reservoir, according to examples of the disclosure.

FIG. 7 is a schematic diagram of illustrative client devices where one or more metrics associated with a user's financial situation is displayed, according to examples of the disclosure.

FIG. 8 is a flow diagram of an illustrative method to set up a user's financial data feed from one or more financial institutions, according to examples of the disclosure.

FIG. 9 is a flow diagram of an illustrative method to receive a user's financial transaction data from one or more financial institutions, according to examples of the disclosure.

FIG. 10 is a schematic diagram of illustrative client devices that display financial transaction data and tracking over time of financial transaction data and/or financial metrics, according to examples of the disclosure.

FIG. 11 is a flow diagram of an illustrative method to enable a user to engage a financial advisor, according to examples of the disclosure.

FIG. 12 is a system and network diagram that shows an illustrative operating environment that includes a system that can be configured to implement aspects of the functionality described herein, according to examples of the disclosure.

FIG. 13 is a computing system diagram illustrating a configuration for a data center that can be utilized to implement aspects of the technologies disclosed herein, according to examples of the disclosure.

FIG. 14 is a network services diagram that shows aspects of several services that can be provided by and utilized within a system, or a larger system of which the system is a part, which is configured to implement the various technologies disclosed herein, according to examples of the disclosure.

FIG. 15 is a computer architecture diagram showing an illustrative computer hardware architecture for implementing a computing device that can be utilized to implement aspects of the various technologies presented herein, according to examples of the disclosure.

FIG. 16 is a schematic diagram of an illustrative user interface displayed on a financial advisor system showing user financial data for a plurality of users over a particular time frame, according to examples of the disclosure.

FIG. 17 is a schematic diagram of an illustrative user interface displayed on a financial advisor system showing user financial data for a plurality of users over a time frame that is different from the time frame of FIG. 16, according to examples of the disclosure.

FIG. 18 is a schematic diagram of illustrative user interfaces displayed on a financial advisor system for sending a message to a particular user, according to examples of the disclosure.

FIG. 19 is a schematic diagram of an illustrative user interface displayed on a financial advisor system showing financial information of a user, according to examples of the disclosure.

FIG. 20 is a schematic diagram of an illustrative user interface displayed on a financial advisor system showing cash inflow financial information from earned income of the user of FIG. 19, according to examples of the disclosure.

FIG. 21 is a schematic diagram of an illustrative user interface displayed on a financial advisor system showing capital allocations of the user of FIG. 19, according to examples of the disclosure.

FIG. 22 is a schematic diagram of an illustrative user interface displayed on a financial advisor system showing financial achievements of the user of FIG. 19, according to examples of the disclosure.

FIG. 23 is a schematic diagram of an illustrative user interface displayed on a financial advisor system showing financial outflows of the user of FIG. 19, according to examples of the disclosure.

FIG. 24 is a schematic diagram of an illustrative user interface displayed on a financial advisor system showing uncategorized financial transactions of the user of FIG. 19, according to examples of the disclosure.

FIG. 25 is a schematic diagram of an illustrative user interface displayed on a financial advisor system showing graphical display of financial outflows and financial inflows of the user of FIG. 19, according to examples of the disclosure.

FIG. 26 is a schematic diagram of an illustrative user interface displayed on a financial advisor system showing financial events associated with the user of FIG. 19, according to examples of the disclosure.

FIG. 27 is a schematic diagram of an illustrative user interface displayed on a financial advisor system for indicating a future event note of the user of FIG. 19, according to examples of the disclosure.

FIG. 28 is a schematic diagram of illustrative user interfaces displayed on a financial advisor system for categorizing a financial transaction of the user of FIG. 19, according to examples of the disclosure.

### DETAILED DESCRIPTION

This disclosure is directed to one or more computing services, such as a software as a service (SaaS), that provide consolidated financial data and condensed metrics that allow for improved understanding and control over one's financial situation. The services, as implemented by the systems, methods, and apparatuses disclosed herein, can improve the quality of a user's engagement with his or her own financial health. The mechanisms disclosed herein can allow users to visualize their financial performance over time, such as over selectable time ranges. Additionally, the mechanisms, as disclosed herein, can allow for a user to engage with one or more financial advisors securely and according to parameters and conditions of engagement for which the user can have a relatively high level of agency.

According to various examples, a service system, such as a FLO service system can be configured to provide and/or enable financial tracking, goal setting, information consolidation, advisory, and/or other services for users. These users, in some cases, can have multiple financial accounts of various types and at various financial institutions. The FLO service system can be configured to receive permissions and/or authentication credentials from users to retrieve financial transactions made by the users. The FLO system can use the user's authentication credentials to interface with financial institution systems to retrieve financial transaction data pertaining to the user. For example, the FLO system can retrieve deposit and withdrawal transaction data from the user's bank account, dividend payments in the user's brokerage account, spending in the user's credit card account, and the like.

The FLO system can retrieve the financial transaction data from the financial institution systems in an asynchronous manner, such as by requesting and/or pulling the financial transaction data pertaining to the user at a particular time from each of the financial institutions, and financial institution systems thereof. The financial transaction data can be retrieved and stored in association with the user and/or his or her user profile. The FLO system can also perform a check to determine that there are no financial transactions that can be duplicates of previous financial transactions that were received from the financial institution systems at a previous time period, such as in the previous day, if financial transaction data is pulled daily. In this way, the FLO system can be able to collect, over time, financial transaction data associated with a user, even if that financial transaction data is sourced from multiple financial institutions.

Although an asynchronous mechanism of gathering financial transaction data is discussed, it should be understood that the disclosure herein also contemplates a synchronous and/or near-synchronous financial transaction data feed to the FLO service system. In other words, financial transaction data can be received real-time and/or near real-time as financial transactions take place for a particular user. Additionally, although a pull mechanism for obtaining financial transaction data is discussed herein, it should be understood that the disclosure herein encompasses a mechanism where financial transaction data can be pushed by the financial institution systems to the FLO service system for users that are associated with the FLO service system, either synchronously or asynchronously. It should still further be understood that the FLO system can accept financial transaction data from the user, in addition to the financial institutions associated with the user.

In examples, the FLO service system can access financial transaction data for multiple users from each of the financial institution systems with which the FLO service systems interact. For the purposes of efficiency in retrieving financial transaction data, the FLO service system can obtain financial transaction data for multiple users who have accounts at a particular financial institution and are associated with the FLO service. After receiving the financial transaction data for multiple users, the FLO service system can sort the financial transaction data by user and associate each of the financial transaction data with its corresponding user profile. The FLO system can then retrieve financial transaction data from the next financial institution system in a similar manner and repeat this process until all of the financial transaction data for all of the users associated with the FLO service system is obtained.

The FLO service system, after receiving financial transaction data can classify the financial transaction data as an inflow transaction, an outflow transaction, and/or other transaction. For example, if a user's salary was direct deposited into their brokerage account or bank account, then that financial transaction can be classified as an inflow transaction. On the other hand, if a user makes a debt payment for his or her student loan, then that financial transaction can be classified as an outflow transaction. Other transactions can be transactional. For example, if a user moves money from his or her checking account to his or her savings account, the debit and credit transaction can be netted out as being transactional without any net inflow and/or outflow resulting therefrom. In this way, the FLO system can classify a particular user's financial transaction data.

In some examples, a user can have a primary reservoir account to which deposits and/or withdrawals can be made. The FLO service system can be configured to obtain financial transaction data from this primary reservoir account. Financial transaction data that represent deposits into this primary reservoir account can be inflow transaction data and, similarly, the withdrawals can represent outflow transaction data. In some cases, a transaction out of the primary reservoir account, such as to another reservoir account or in investment account, may not represent an outflow, but rather a transfer of fund between various reservoir accounts. Thus, in examples, the FLO service system can be configured to determine a user's overall inflow and outflow financial transactions based at least in part on financial transaction data retrieved from the primary reservoir account.

It should be understood that the primary reservoir account can be a brokerage account or other suitable account that can be managed by a financial advisor. Alternatively, the primary reservoir account can be a bank account, savings account, checking account, money market account, or indeed any suitable deposit account from which financial transaction data can be received and used to determine a user's financial inflows and/or financial outflows over any period of time. In some cases, the primary reservoir account can be a joint account. For example, a couple can have all of their family inflow and/or outflow transactions tracked through the primary reservoir account. For example, a husband and a wife can deposit both of their paychecks into their joint primary reservoir account, and as money is shifted from the primary reservoir account to other accounts, the inflow financial transactions and outflow financial transactions of the family can be tracked based at least in part on the financial transaction data associated with the primary reservoir account.

After classifying and analyzing a user's financial transaction data, the FLO system can be configured to determine one or more financial metrics associated with the user. For example, the FLO service system can be configured to calculate a free cash flow for the user over a particular period of time, such as one month, one quarter, year-to-date, since inception, a user defined date range, etc. The free cash flow can be calculated as a difference between the sum of all of the inflows of money and the sum of all the outflows of money during a particular time period. The free cash flow can also be referred to as how much money goes into an aggregate reservoir over the particular period of time. The free cash flow can be positive if the user saves money during the particular period of time, and can be negative if the user spends more money than he or she earns during the particular period of time.

FLO service system can further use the determination of the free cash flow over the time period to determine a FLO score. The FLO score can be a percentage of the free cash flow relative to the user's overall outflow of money. This FLO score can be used as a metric for comparison of the user's savings performance relative to various comparison situations. For example, the FLO score can be compared to a FLO score target set by the user. As another example, the FLO score of the user can be compared over a longer time period, such as looking at a user's FLO score every month over the past five years. Yet another example use of the FLO score metric can be to compare the FLO score of a user relative to other users, such as an average of other users with a similar income level, or a median of other users who live in a similar cost of living area, or the like. Indeed, the FLO score can serve as a compact and versatile metric that allows a variety of comparisons to determine a relative performance of savings.

The FLO service system can still further determine a FLO rating based at least in part on the FLO score. In examples, the FLO service system can bin the FLO score into separate bins (e.g., DANGER, POOR, GOOD, EXCELLENT, OUTSTANDING, etc.) to indicate a relative level of performance. In examples, the bin boundary values can be predefined. In other cases, the bin boundary values can be set according to each user's goals, peers, income level, location, cost-of-living index, retirement needs, years till retirement, and/or any variety of other factors.

According to examples of the disclosure, a user can be able to visually see his or her free cash flow and savings performance based at least in part on the metrics as discussed herein. Additionally, these metrics can be determined for variable time periods, and can be visualized over those different time periods. The user can be able to see his or her FLO score, for example, over several time periods, such as consecutive months. This allows the user to see his or her savings performance over time and understand how much money is accumulating or depleting, over time, from an aggregated reservoir. The visualization can indicate to a user how much money they keep over time.

The FLO service system can be configured to generate financial metrics for a user over variable time period based at least in part on a selection of the time period by the user. For example, a user can feel that his or her FLO score is more meaningful over a quarter or half year, rather than monthly. In this case, the user can be able to track his or her FLO score on a quarterly or half-yearly basis. Additionally, the FLO service system can be configured to generate various statistics over time based at least in part on the FLO score. For example, a user can wish to track his or her savings performance based at least in part on a moving average of the FLO score, such as a 15 day moving average, a 90 day moving average, or a 365 day moving average. In this way, sharp movements, such as movements and/or features arising from inconsistent timing of inflows and outflows of money can be smoothed out to generate a more meaningful tracking metric of an individual's savings performance.

According to additional embodiments of the disclosure, the user can be able to download an application to his or her client device to see his or her financial transaction data and/or financial metrics. The client device can cooperate with the FLO service system via one or more application programming interfaces (APIs) and/or other standardized interfaces or predefined data structures for communications therebetween. The client device can receive data, such as financial transaction data and/or financial metrics, as discussed herein, that the client device can display thereon to the user. The client device, and the application operating thereon, can further be configured to solicit, such as based at least in part on user input, different data (e.g., metrics over different time periods) from the FLO service system. Further still, the client device can be configured to send messages and/or instructions, based at least in part on user input, to the FLO service system to route to appropriate recipients, such as financial institution systems and/or a financial advisor system.

The client device, in examples, can be any suitable device from which the user can access his or her FLO service system data. For example, and without limitation, the client device can be a smartphone (e.g., APPLE IPHONE X, SAMSUNG GALAXY S7 EDGE), laptop computer, desktop computer, a tablet computing device, or indeed, any suitable computing device. The client device can further operate on any suitable operating system (O/S), such as Windows, iOS, Android (e.g., ANDROID 8.0 OREO), Linux, or the like. The application operating on the client device to interface with the FLO service system can be obtained (e.g., downloaded) from any suitable location, such as an application store (e.g., GOOGLE APP STORE, APPLE ISTORE, etc.), from the FLO service system itself, or any other server and/or location. In alternative embodiments, the FLO service system can be configured to interact with the user via a web interface, rather than an application, via his or her client device.

In examples, the client device can also provide the user the ability to provide the FLO service system with an indication of his or her financial accounts. In other words, the user, via his or her application operating on his or her client device, can be configured to select one or more financial institutions where he or she can have financial accounts. The client device, and the application operating thereon, can also enable the collection and/or secure transmission of user authentication credentials for one or more financial institution systems from where the FLO service system can obtain financial transaction data. For example, a user can be able to provide his or her login and password, and optionally additional authentication information (e.g., two-factor authentication), to the FLO system for his or her checking account, savings account, mortgage account, student debt account, credit card account, and/or the like, by interacting with his or her client device.

The client devices can further be configured to provide the user with an ability to select, confirm, and/or set permissions for a financial advisor. In some cases, a financial advisor, such as via a financial advisor system, can send a request to provide financial advisory services to, or otherwise work with, a particular user to the FLO service system. In this case, the FLO service system can query the user via his or her client device whether he or she would like to be associated with the financial advisor. In other cases, the user can initiate association with a particular financial advisor.

After the financial advisor has been associated with the user, the user can be able to set permissions related to the level of access the financial advisor can have to the user's profile. For example, the user can set permissions for the financial advisor to only see financial transaction data and/or financial metric values, without the advisor being allowed to make transactions on behalf of the user. In other cases, the user can set permissions for the financial advisor so that the financial advisor can be able to not only view the user's financial transactions and financial metric values, but also to make financial transactions on behalf of the user. Indeed, there can be any variety of independent permissions that the user can have agency in setting when interacting with a financial advisor of his or her choosing. Furthermore, since the FLO service system can provide the platform on which the user can interact with the financial advisor, the financial advisor can be able to take permitted actions on behalf of the user without the financial advisor having complete and unfettered access to the user's financial accounts.

In further examples, the FLO service system can enable messaging between parties associated with the FLO service system. For example, a financial advisor can be able to send messages (e.g., recommendations to rebalance a portfolio) to a user via his or her financial advisor system in any suitable format (e.g., text-based, voice-based synchronous/phone call, voice-based asynchronous, video message, etc.). Similarly, a user can be able to send messages in any suitable format to his or her associated advisor system(s) and/or financial institution system(s).

It should be appreciated that the systems and mechanisms as described herein, can improve the field of financial management. The mechanism disclosed herein provide one the ability to understand and have control over his or her income, spending and savings. In the Internet age, people have experienced a proliferation of financial account offerings that present a variety of financial services and products. This has led to technical challenges in keeping track of one's spending and savings. This challenge can arise due to the tendency of a relatively large number of financial accounts obfuscating one's financial performance. For example, with common platforms and mechanism for movement of money (e.g., automated clearing house (ACH), person-to-person (P2P) payments, etc.), many of which are enabled by modern networking technology, technical challenges arise in tracking and understanding how one spends money. The disclosure herein provides a technical solution to this technical problem. The technical solution includes consolidating financial transactions across multiple financial institutions, so that one can visualize his or her financial situation across multiple or all of his or her financial accounts.

The technical solutions provided herein, are not only directed to technical problems that arise in the Internet era in fragmentation of data, but also address technological solutions in other fields, such as personal finance. By determining, tracking, and displaying, such as via a graphical user interface (GUI) of computing devices, compact metrics for comparison of one's personal financial performance result in improvements in one's understanding and control over their finances. Therefore, it should be understood that the technical solutions provided herein pertain to solving problems that arise in the Internet era, while providing technological improvements in the financial industry.

The techniques and systems described herein can be implemented in a number of ways. Example implementations are provided below with reference to the following figures.

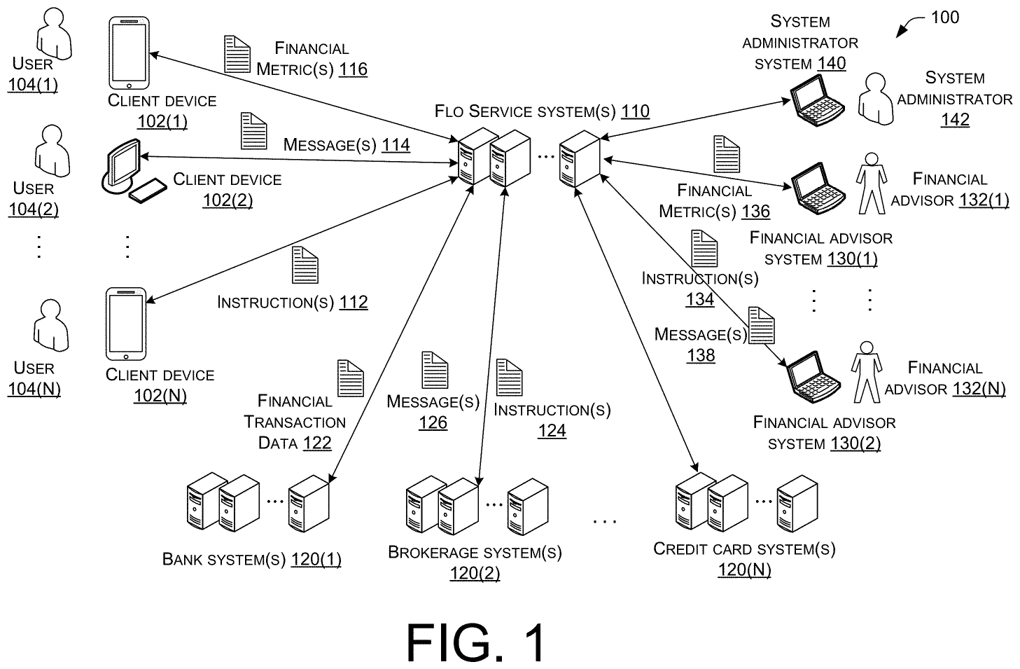

FIG. 1 is a schematic diagram of an illustrative environment 100 that includes services and systems to enable tracking cash flow and savings performances by users 104(1), 104(2), . . . 104(N), and/or their financial advisors 132(1) . . . 132(N), according to examples of the disclosure.

The users 104(1), 104(2), . . . 104(N) (hereinafter referred to individually or collectively as user 104 or users 104) can interact with their respective client devices 102(1), 102(2), . . . 102(N) (hereinafter referred to individually or collectively as client device 102 or client devices 102). The environment 100 can further include one or more cash flow service system(s), referred to hereinafter as FLO service system(s) 110 or FLO service system 110. The FLO service system(s) 110 can further be configured to interact with bank service system(s) 120(1), brokerage service system(s) 120(2), and/or credit card system(s) 120(N) (hereinafter referred to individually or collectively as financial institution system(s) 120). The FLO service system(s) 110 can still further be configured to interact with one or more financial advisors 132(1), . . . , 132(N) (hereinafter referred to individually or collectively as financial advisor 132 or financial advisors 132), via their financial advisor systems 130(1), . . . , 130(N) (hereinafter referred to individually or collectively as financial advisor system 130 or financial advisor systems 130). The FLO service system(s) 110 can yet further be configured to interact with a system administrator 142 via his or her system administrator system 140.

The client devices 102 can have an application operating thereon, with which the users 104 can interact. Although three different client devices 102 are depicted in FIG. 1, in examples, there can be any number or type of client devices 102 on which users 104 can be using their applications. Client devices 102 that can be configured to run an application with which a user 104 interacts can include, but is not limited to, smartphones, tablet computers, smart televisions, set-top boxes, computers, computing devices, servers, notebook computers, netbook computers, personal digital assistants (PDAs), smart appliances, in-vehicle infotainment systems (IVIs), wearable computing devices, combinations thereof, or the like.

The application that interacts with the FLO service system(s) 110 can be provided on the client device 102 by any suitable mechanism. For example, the application can be preloaded on the client device 102 or downloaded to the client device 102, such as from a play store, application store, the FLO service system(s) 110, or from any other suitable source of the application. The application, as operating on the client devices 102, can enable the client devices 102 to interact with the one or FLO service system(s) 110 to communicate therebetween, via any suitable network and using any suitable standardized interfaces (e.g., APIs, standardized data structures, etc.). The data structures can provide a predefined organization of the data that is to be exchanged between the client device 102 and the FLO service system(s) 110. The data structures can be defined for any suitable level of granularity, order, length, and/or precision of data as can be needed for conveying financial transaction data and/or related financial metrics between the FLO service system(s) 110 and the client devices 102. The application that operates on the client device 102 can enable a user 104 associated with that client device 102 to access his or her user profile, user data, and/or other information on the FLO service system(s) 110. Although the disclosure herein discusses interactions between the client device 102, with the application operating thereon, interacting with the FLO service system 110, such as via APIs or other standardized interfaces and/or data structures, it will be understood, that in other examples, the FLO service system 110 can be configured to operate as a webserver and the users 104 can be able to interact with their personal information on the FLO service system 110 via a web browser operating on their respective client device 102.

The client devices 102 can be configured to interact with the FLO service system(s) 120 by any suitable mechanism, including one or more networks that can include any viable communication technology, such as wired and/or wireless modalities and/or technologies. Networks can include any combination of Personal Area Networks (PANs), Local Area Networks (LANs), Campus Area Networks (CANs), Metropolitan Area Networks (MANs), extranets, intranets, the Internet, mobile telephony networks, Wi-Fi, other short-range wireless communication networks (e.g., ZigBee®, Bluetooth®, etc.), Wide Area Networks (WANs)—both centralized and/or distributed—and/or any combination, permutation, and/or aggregation thereof. The same or similar network(s) and/or communications technologies can be used for interactions between and/or among the FLO service system(s) 110, the financial institution system(s) 120, the financial advisor system(s) 130, the system administrator system(s) 140, or any other suitable entity of environment 100.

The application, as operating on the client devices 102, can be configured to send and/or receive instruction(s) 112, message(s) 114 and/or financial metric(s) 116 to and/or from the FLO service system(s) 110. The instructions 112 sent from the client device 102 to the FLO service system(s) 110 can instruct the FLO service system(s) 110 to perform one or more actions related to the user's profile and/or the user's financial transaction data and metrics. Further still, the instructions 112 from the client devices 102 to the FLO service system(s) 110 can include instructions 112 that can be routed to one or more financial institutions system(s) 120 to effect one or more transactions (e.g., wire transfers, ACH transfers, stock sale etc.) at the one or more financial institution system(s). The instructions sent from the FLO service system(s) 110 to the client devices 102 can include instructions to the application to display any variety of financial transaction information and/or solicit a response from the corresponding user.

The message(s) 114 sent from the FLO service system(s) 110 can include messages (e.g., voice messages, text messages, etc.) from any one of a system administrator system 140, a financial advisor system 130, and/or from a financial institution system 120. Similarly, the message(s) 114 sent from the client device 102 to the FLO service system 110 can be routed by the FLO service system 110 to one or more financial institution system(s) 120, financial advisor system(s) 130, and/or system administrator system 140. These messages can incorporate financial advice, supplemental instructions, clarifications associated with financial transactions and/or financial accounts, questions, solicitation of advice, combinations thereof, or the like.

The financial metric(s) 116 can include any variety of financial information that is generated from a user's financial transaction data, such as value of reservoirs (e.g., accounts where funds can be stored), a value of an aggregate reservoir, free cash flow over a particular time period, a collection of free cash flows over various time periods, a FLO score (e.g., a percentage of savings relative to fund outflows) over a particular time period, a FLO score over various time periods, a FLO rating (e.g., an indication of savings performance), and/or FLO ratings over a particular time period.

The FLO service system(s) 110 can further be configured to send and/or receive financial transaction data 122, instructions 124, and/or messages 126, to and/or from the financial institution system(s) 120. The financial transaction data 122 can be sent by the financial institution system(s) 120 to the FLO service system(s) 110. This financial transaction data 122 can include, for example, financial transaction data 122 over a predetermined time period. In examples, the financial transaction data 122 can be obtained by the FLO service system(s) 110 in a periodic manner and this financial transaction data 122 can be financial transaction data 122 that has been generated at a financial institution system 120 since the last receipt of financial transaction data 122 from that financial institution system 120 for a particular user 104. For example, is financial transaction data 122 is obtained daily, then the FLO service system 110 can receive and/or solicit the financial transaction data for a particular user 104 that has been generated over the last 24 hours. In this way, the FLO service system 110 can prevent duplication of financial transaction data 122 as received from the various financial institution system(s) 120.

In examples, the FLO service system(s) 110 can have a designated target reservoir balance associated with each of the users 104. This can enable the advisor 132 and user 104 to manage financial health.

In examples, the instructions 124 as sent from the FLO service system(s) 110 to the financial institution system(s) 120 can include instructions 124 to send the financial transaction data 122. Thus, the instructions 124 can include solicitations of the financial transaction data 122. The solicitation of the financial transaction data 122, as sent by the FLO service system(s) 110, can include authentication credentials (e.g., login, password, secondary authentication credentials, authentication certificate(s), etc.) associated with individual ones of users 104 for whom financial transaction data 122 is to be received.

The instructions 124 can further include instructions 124 to cause a financial transaction by and/or between one or more financial institution system(s) 120. These instructions 124 can originate from users 104, via their respective client devices 102, and/or financial advisors 132, via their respective financial advisor systems 130. These instructions can include, but are not limited to, deposit, withdrawal, bill payment, funds transfer, ACH transfer, wire transfer, person-to-person (P2P) payment, electronic debit via any suitable rail, equity purchase, equity sale, equity short sale, initiating a margin loan, any suitable equity trade, a debt purchase, a debt sale, a debt short sale, any suitable debt (including sovereign debt) security transaction, an option purchase, writing an option, placing a covered call equity-option trade, placing a collar trade, placing a covered put equity-option short sale trade, placing a calendar spread trade, placing a vertical spread trade, placing any suitable spread trade, placing a straddle trade, any suitable options, futures, swaps, and/or derivatives trade, buying or selling foreign currencies or derivative instruments thereof, buying or selling cryptocurrencies, ZELLE, PAYPAL, VENMO, combinations thereof, or the like.

In some cases, transaction instructions 124 and/or sharing of financial metrics can be indelibly recorded, such as by using a blockchain. This can create a chain of trust in the handling of sensitive financial data, as well as ascribe responsibility to actors based at least in part on their roles and the financial data that they can have accessed.

The FLO service system(s) 110 can further be configured to receive and/or send messages 126 to the financial institution system(s) 120 that can have originated from a user 104, via his or her client device 102, and/or financial advisor 132, via his or her financial advisor system 130. These messages 126 can be written, read, and/or responded to by the user(s) 104 and/or financial advisor(s) 132.

The FLO service system(s) 110 can still further be configured to send and/or receive instructions 134, financial metrics 136, and/or messages 138, to and/or from the financial advisor system(s) 130. The instructions 134 to the financial advisor systems 130 can include instructions 134 to display certain financial transaction data and/or metrics. The instructions 134 received from the financial advisor system(s) 130 can include instructions 134 to provide certain financial transaction data, user profile data, and/or metrics associated with particular ones of users 104 with whom the financial advisor 132 with whom the financial advisor system 130 is associated. The instructions 134 can further include instructions that can be routed to one or more financial institution system(s) 120 via the FLO service system 110. In some cases, metrics pertaining to financial advisor performance can be generated. These financial advisor performance metrics can be shared with financial advisors 132 and/or users 104.

The financial metrics 136 can be sent by the FLO service system 110 to the financial advisor system(s) 130 to indicate the financial and/or savings performance of the user 104. In some cases, the FLO service system 110 can send one or more metrics pertaining to multiple users 104 with whom a particular financial advisor 132 can have a professional relationship. For example, if a particular financial advisor 132 has a financial advisory relationship with five different users 104 associated with the FLO service system 110, then that financial advisor 132 can be able to receive a FLO score, as described herein, over the last month for those five users 104 on his or her financial advisor system 130. In this way, the financial advisor 130 can be able to interact with the FLO service system(s) 110 to receive compact indications of how his or her clients can be performing from a savings standpoint. Of course, the financial advisor 132 can choose different types of metrics (e.g., a FLO score over a different time period, a median FLO score over the past year, etc.) for the users 104 to whom he or she provides financial advisory services. In that case, those metrics 136 can be dynamically generated by the FLO service system(s) 110 and sent to the financial advisor system(s) 130 associated with the financial advisor 132.

The messages 138 can originate, in examples, from users 104, via their client devices 102 and routed through the FLO service system(s) 110 to the financial advisor system(s) 130. Alternatively, the messages 138 can originate, in examples, from financial advisors 132, via their financial advisor systems 130 and routed through the FLO service system(s) 110 to the client devices 102.

A system administrator 142 can be able to access the FLO service system 110 via a system administrator system 140. The system administrator 142 can be able to maintain the FLO service system(s) 110. In some cases, the system administrator 142 can be able to operate as a super user, and can be able to solve any system problems that users 104, financial institutions, and/or financial advisors 132 can face in interacting with the FLO service system(s) 110.

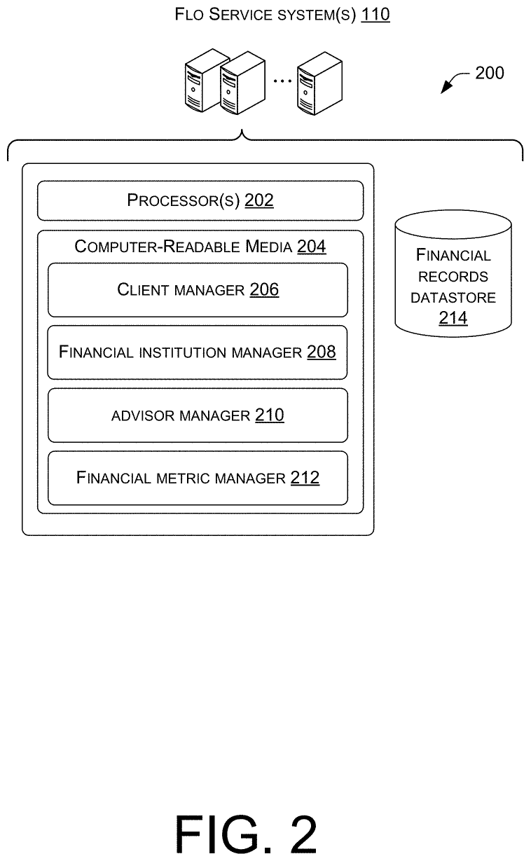

FIG. 2 is a block diagram of an illustrative computing architecture 200 of a FLO service system 110 for aggregating financial data and providing financial tracking and savings oriented metrics, as shown in FIG. 1, according to examples of the disclosure.

The computing architecture 200 can include one or more processors 202 and one or more computer readable media 204 that stores various modules, applications, programs, or other data. The computer-readable media 204 can include instructions that, when executed by the one or more processors 202, cause the processors to perform the operations described herein for the analytics service system(s) 120.

In some implementations, the processors(s) 202 can include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 202 can possess its own local memory, which also can store program modules, program data, and/or one or more operating systems. The one or more processor(s) 202 can include one or more cores.

Embodiments can be provided as a computer program product including a non-transitory machine-readable storage medium having stored thereon instructions (in compressed or uncompressed form) that can be used to program a computer (or other electronic device) to perform processes or methods described herein. The computer-readable media 204 can include volatile and/or nonvolatile memory, removable and non-removable media implemented in any method or technology for storage of information, such as computer-readable instructions, data structures, program modules, or other data. The machine-readable storage medium can include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments can also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks.

In some embodiments, the computer-readable media 204 can store a client manager 206, a financial institution manager 208, an advisor manager 210, and a financial metric manager 212, which are described herein. The components can be stored together or in a distributed arrangement. The computing architecture 200 can include and/or have access to a financial records datastore 214.

The client manager 206 can have instructions stored therein that, when executed by the processor(s) 202, enables the FLO service system(s) 110 to intake a new user 104, set up a user profile for the user 104 with which the user's administrative and financial transaction data can be associated, and update any user related interactions, as needed. The user profile can include and/or be linked with the user's authentication credentials needed for accessing the user profile from a client device 102. The user profile can also be linked with information about the user (e.g., name, age, contact information, financial advisor(s) linkage, permissions for financial advisors, investment philosophy, risk appetite, savings goals, etc.). Additionally, the financial transaction data associated with the user 104 can be linked to and organized with his or her user profile. The user profile linked with a user's financial transaction data can be stored in the financial records datastore 214 for retrieval when the data is needed by the FLO service system(s) 110, such as for the purposes of dynamic financial metric calculations.

The financial institution manager 208 can have instructions stored therein that, when executed by the processor(s) 202, enables the FLO service system(s) 110 to interact with the financial institution system(s) 120. For example, the FLO service system(s) 110 can be configured to solicit and/or receive financial transaction data from the financial institution system(s) 120. The FLO service system(s) 110 can be configured to provide authentication credentials associated with a user and a financial account at a financial institution to access financial transaction data from the financial institution system(s) 120. The authentication credentials can be received by the FLO service system(s) 110 from the users 104, such as via their respective client device 102. The FLO service system(s) 110 can also be configured to send instructions to the financial institution system(s) 120 to perform one or more financial transactions. These instructions for the financial transactions can originate from the client devices 102 and/or the financial advisor systems 130.

The advisor manager 210 can have instructions stored therein that, when executed by the processor(s) 202, enables the FLO service system(s) 110 to interact with the financial advisor system(s) 130 to receive requests from the financial advisor systems 130 and/or send financial transaction data and/or financial metrics to the financial advisor systems 130. In some cases, the FLO service system(s) 110 can provide information responsive to a financial advisor system 130 requesting the information. For example, a particular financial advisor 132, via his or her financial advisor system 130, can request the latest quarter's FLO score for all of the users 104 with whom he or she is associated. The FLO service system 110, responsive to this request, can be configured to provide this information to the financial advisor system 130 of the financial advisor 132.

The financial metric manager 212 can have instructions stored there in that, when executed by the processor(s) 202, enables the FLO service system(s) 110 to determine various financial metrics dynamically. Often these metrics can be determined responsive to user 104 and/or financial advisor 132 requests. The metrics can be determined according to various algorithms. For example, a user 104, via his or her client device 102, can be able to indicate his or her desire for particular metrics, and the FLO service system(s) 110 can be able to determine those metrics dynamically and responsive to the user's requests. Similarly, the FLO service system(s) 110 can be configured to provide financial metrics to financial advisors 132 that are authorized, such as by users 104, to get those metrics via their financial advisor systems 130.

In calculating financial metrics, the FLO service system(s) 110 can classify financial transactions corresponding to a particular user 104 as an inflow or an outflow. Inflow transactions can financial transactions that can be credits to a financial account of the particular user 104. Outflow transactions can be financial transactions that can be a debit form a financial account of the particular user 104. For example, a direct deposit of the user's paycheck can be classified as an inflow, while a credit card payment from that same account can be an outflow. In some cases, the FLO service system(s) 110 can be configured to not double count transactions that are classified as either inflows or outflows. For example, a credit card can have a number of transactions that individually can be considered outflows, but can be an aggregate outflow when the credit card bill is paid from one's checking or savings account. In this case, the FLO service system(s) 110 can consider the outflows when the spending occurs or when the credit card bill is paid, but not both, as that would lead to double counting outflow transactions. In this way, the FLO service system(s) 110 can have established protocols as to which financial transaction data to classify as an inflow or an outflow.

In general, inflows can increase the value of a reservoir account (e.g., a brokerage account, bank account, etc.), while an outflow can reduce the value of a reservoir account. A summation of all of a user's reservoir account can provide a value of an aggregate reservoir. The value of an aggregate reservoir can increase over a time period if inflows are greater than outflows during that time period. This is a situation where there is a positive free cash flow during that time period and the user 104 saves money during that time period.

The FLO service system(s) 110, in some examples, can further be configured to classify a user's financial transaction data with a greater granularity, in some cases responsive to the user's or his or her financial advisor's request, than just inflows and outflow. For example, inflow transactions can be labeled with sources of that inflow, such as, for example, salary, interest income, dividend from stock X, private equity investment payout, capital gains from Y, payments from rental, payments from K-corporation Z, so on and so forth. Similarly, outflow transactions or expenses, can also be classified with a relatively high level of granularity, such as food, rent, mortgage, clothing, tuition, daycare, restaurants, department stores, hotels, etc. In some cases, the financial transaction data can be classified by the financial institution from where the financial transaction data is received. For example, a bank account can classify salary based at least in part upon a name of an entity (e.g., an employer) that makes a direct deposit to a user's bank account. Similarly, a credit card can classify a type of expenditure based at least in part on the merchants where the transactions occurred, such as restaurants, grocery stores, department stores, drug stores, online retailers, or the like. Additionally, or alternatively, the FLO service system(s) 110 can be configured to classify financial transactions with a granularity greater than the level of inflow vs. outflow, based at least in part on the source of the financial transaction data 122 and/or pattern matching to previous transactions and their classifications. In yet further examples, the FLO service system(s) 110 can solicit, from a user 104 and/or a financial advisor 132, via their client device 102 and/or financial advisor system 130, a classification of financial transaction data 122.

The FLO service system(s) 110 can be configured to generate financial metric values over particular time periods. These financial metrics can be innovative ways to track one's savings performance and serve as improvements over traditional mechanisms of personal financial tracking. These metrics, such as FLO scores, can be a compact and useful metric for tracking one's savings performance. Users 104 can be able to request, via their client devices 102 running the FLO application, financial metrics, such as the FLO score, over different time periods. The FLO service system(s) 110 can be responsive to these requests and provide the FLO scores, or other financial metric values, responsive to requests for these values.

A financial metric that can be generated by the FLO service system(s) 110 can include a free cash flow (FCF) over a predefined time period. The free cash flow can be defined as follows:

Free Cash Flow=ΣInflows−ΣOutflows (Equation 1)

In other words, the free cash flow over a particular time period can be calculated as a sum of the inflows during a time period minus the sum of all the outflows during that time period. If a user 104 wishes to view his or her free cash flow over a different time period, then the user 104 can specify that time period (e.g., a month, a quarter, a half year, a week, a year, three years, etc.), and the FLO service system(s) 110 can be configured to determine the free cash flow over the desired time period using financial transaction data linked with the user profile of the user 104.

Another financial metric that can be generated by the FLO service system(s) 110 can include a FLO score that can be calculated as follows:

$$FLO Score = 100 * \frac{\sum Inflows - \sum Outflows}{\sum Outflows} \qquad ( Equation 2 )$$

In other words, the FLO score over a particular time period can be calculated as 100 times a sum of the inflows during a time period minus the sum of all the outflows during that time period (i.e., free cash flow during the time period) divided by the sum of the outflows during the time period. If a user 104 wishes to view his or her FLO score over a different time period, then the user 104 can specify that time period (e.g., a month, a quarter, a half year, a week, a year, three years, etc.), and the FLO service system(s) 110 can be configured to generate the FLO score over the desired time period. Analogous to a credit score, the FLO score can indicate a person's savings health and/or whether a person is living within this or her means.

Yet another metric that the FLO service system(s) 110 can generate includes a FLO score rating. This rating can be determined by binning FLO scores and ascribing a syntactic descriptor thereto. This descriptor can convey meaning and/or context to a user 104 or a financial advisor 132 of an individual's savings performance. An example binning and FLO score rating can be as shown in the chart below:

TABLE 1

| FLO Score | FLO Score Rating |
|---|---|
| <0 | Danger |
| >0-10 | Poor |
| 11 thru 25 | Moderate |
| 26 thru 50 | Good |
| 51 thru 100 | Excellent |
| ≥101 | Exceptional |

The “Danger” rating can be indicative of someone who would have consumption or outflows in excess of inflows or income (both passive or earned). An extended period of time in this zone can be problematic in achieving a requisite amount of savings for one's future needs. The “Poor” rating might be indicative of someone who is spending all or most of their inflows and may not be able to build a savings balance. The “Moderate” rating may indicate a situation with minimal free cash flow or a nominal saving rate. In this case, life can eventually present a situation that would lead to dipping into the modest amount of reserves created by this level of flow scores. The “Good” rating can indicate a free cash flow that would be promoting growth of free capital or reserves. This person would be able to periodically add capital to other assets or investments that might produce even further free cash flow. The “Excellent” rating can indicate a steady and abundant free cash flow and the ability to make frequent capital decisions like investing, adding capital to investments, and/or adding new investments or assets, further enabling additional passive income to accelerate the FLO score moving forward. The “Exceptional” rating can indicate a situation where someone can have free cash flow greater than or equal to how much they consume or total outflows. This would promote an exceptional environment for creating financial growth in assets and free cash flow.

It should be understood that the binning and the mapping between the FLO score and FLO score rating as shown in Table 1 can be just an example. Indeed, the disclosure herein anticipates any suitable number of bins, ranges of bins, and/or correlation of FLO scores to FLO score ratings.

Still another metric that the FLO service system(s) 110 can generate includes a moving average of the FLO score to smooth out any relatively large movements in the FLO score over time. For example, a user 104 can request the FLO service system(s) 110 to generate a moving average of monthly FLO scores over a three month moving window or a twelve month moving window. This is merely an example, and indeed any suitable moving average window and time period can be calculated by the FLO service system(s). Regardless of the window size and/or the baseline time periods, it should be understood that the FLO score moving average can smooth out sharp changes in the FLO score that can result from lump transactions of considerable size, such as a bonus payment, large medical expense, or the like. A calculation to determine a moving average of a FLO score can be as follows:

$$( Equation 3 )$$

$$FLO Score Moving Average = \frac{1}{k} {\sum }_{i = 0}^{k} FLO {Score}_{i} , \\ where , k is an integer number of time periods of the moving$$

$$average window ; and i is an index of a particular FLO Score$$

$$ove r a particular time period .$$

It should be appreciated that he FLO service system(s) 110 can be configured to determine the FLO score moving average with a selectable time period (e.g., weekly FLO score, monthly FLO score, quarterly FLO score, etc.) and/or a selectable window (e.g., 3 time periods, 6 time periods, etc.). In this way, a user 104 and/or his or her financial advisor 132 can be able to view the user's savings performance over a time period and have any spurious data points smoothed out.

Still another example financial metric can include differences between the FLO score from one time period to another. This can be a useful visualization for a user 104 and/or his or her financial advisor 132, as a positive reading can indicate an improvement in the user's savings performance over time, while a negative reading can indicate a deterioration of the user's savings performance over time.

Additional financial metrics can be generated based at least in part on comparisons to other users 104. The FLO service system(s) 110 can have access to a relatively rich set of financial data that allows it to determine how a relatively large number of users 104 are performing with respect to their savings. Thus, the FLO service system(s) 110 can be configured to determine, statistics such as mean, median, and/or mode of FLO scores, free cash flow, or the like of users 104. In some cases, these statistics can be determined after binning users 104 by their income, family size, cost of living index, age, state, educational background, profession, or indeed any variety of quantitative or qualitative demographic parameters. Furthermore, the FLO service system(s) 110 can be configured to provide a comparison of a particular user 104, such as in an anonymized manner, to others in his or her demographic bin. For example, the FLO service system 110 can be configured to provide, for a user 104 making $100,000 per year, a comparison of his or her FLO score over a period of time to an average value of other users with incomes between $90,000 and $110,000 per year. Such comparisons can help the user 104 visualize his or her savings performance relative to others who can be in a similar life situation, at least from a demographic standpoint.

The FLO score for user's can be used by financial advisors 132 to help their clients understand stages of their financial and free cash flow security. In some embodiments, there can be six stages of financial independence. These stages can be, in progression of free cash flow adequacy: Stage 1: Establishing your reserve; Stage 2: Choosing your baseline FLO setting your target; Stage 3: Filling the reservoir; Stage 4: Make your move; Stage 5: Accelerate; and Stage 6: Financial Independence. One can progress through the aforementioned stages through life and a financial advisor 132 can be able to use the FLO score and other tools disclosed herein to guide and/or coach a user 104 forward through these stages.

The FLO service system(s) 110 can further be configured to use artificial intelligence and/or machine learning algorithms to project a user's free cash flow, FLO scores, and/or personal wealth into the future. For example, regression analysis can be used to project one's likely date of reaching certain financial milestones and/or goal. The machine learning algorithms can also project probabilities of early success, such as having enough assets to retire prior to a target retirement data, or late success, such as not having enough assets to retire at a target retirement date.

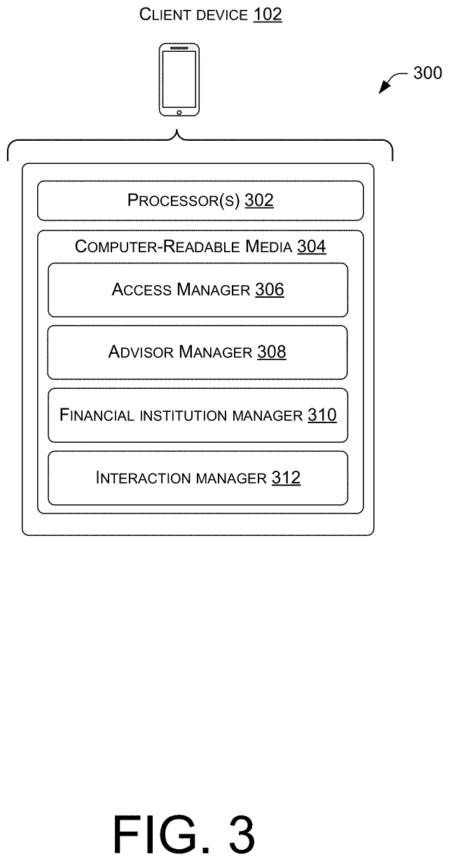

FIG. 3 is a block diagram of an illustrative computing architecture 300 of a client device 102 for interacting with the FLO service system(s) 110, as shown in FIG. 1, according to examples of the disclosure.

The computing architecture 300 can include one or more processor(s) 302 and one or more computer readable media 304 that stores various modules, applications, programs, or other data. The computer-readable media 304 can include instructions that, when executed by the one or more processor(s) 302, cause the processors to perform the operations described herein for the FLO service system(s) 110. The descriptions of the processor(s) 302 and the computer readable media 304 are substantially similar to the descriptions of the processor(s) 202 and the computer readable media 204, respectively, of the FLO service system(s) 110, as described in conjunction with FIG. 2, and in the interest of brevity, will not be repeated here.

In some embodiments, the computer-readable media 304 can store an access manager 306, an advisor manager 308, a financial institution manager 310, and interaction manager 312, which are described herein. The components can be stored together or in a distributed arrangement.

The access manager 306 can have instructions stored therein that, when executed by the processor(s) 302, enables the client device 102 to establish access to the FLO service system(s) 110, such as by setting up a user account with a user profile at the FLO service system(s) 110. In some cases, this can involve providing the FLO service system(s) identifying information about a user 104 for whom a user profile is to be set up. This information can include name, age, date of birth, social security number, address, email address, phone number, and/or other identifying information about the user 104. Once the user profile is set up, other linkages, financial account information, financial advisor information, and/or financial transaction data, can be made to that user profile and accessed by reference to the user profile for the user 104 as established via the client device with the FLO application operating thereon.

The advisor manager 308 can have instructions stored therein that, when executed by the processor(s) 302, enables the client device 102 to enable association of a user's user profile with a financial advisor 132. In some cases, the financial advisor can initiate the association, and in other cases, the user 104 can initiate the association with the financial advisor 132. However, in either case, the user 104 via his or her client device 102 can confirm and/or allow the association with the financial advisor 132.

The financial institution manager 310 can include instructions stored therein that, when executed by the processor(s) 302, enables the client device 102 to provide the FLO service system(s) 110 with financial account identifiers (e.g., financial institution name, financial account number, etc.) and authentication credentials to electronically access the finical accounts. In this way, the user 104 provides the access to his or her accounts to the FLO service system(s) 110 so that the FLO service system(s) 110 are able to perform financial transaction gathering operations on behalf of the user 104, as described herein.

The interaction manager 312 can have instructions stored therein that, when executed by the processor(s) 302, enables the client device 102 to solicit financial metrics data, an achievement assessment that can include the display of one or more financial assessment and/or metric values, or the like. The client device 102 can also be able to request different views of user-specific financial data and display this financial transaction data.

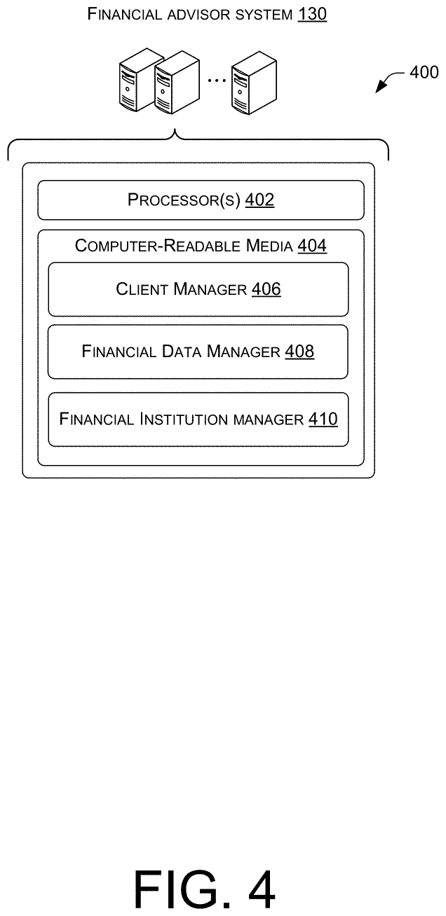

FIG. 4 is a block diagram of an illustrative computing architecture 400 of a financial advisor system 130 for interacting with user financial data, as shown in FIG. 1, according to examples of the disclosure.

The computing architecture 400 can include one or more processor(s) 402 and one or more computer readable media 404 that stores various modules, applications, programs, or other data. The computer-readable media 404 can include instructions that, when executed by the one or more processor(s) 402, cause the processors to perform the operations described herein for the test service system(s) 140. The descriptions of the processor(s) 402 and the computer readable media 404 are substantially similar to the descriptions of the processor(s) 202 and the computer readable media 204, respectively, of the FLO service system(s) 110, as described in conjunction with FIG. 2, and in the interest of brevity, will not be repeated here.

In some embodiments, the computer-readable media 404 can store client manager 406, a financial data manager 408, and a financial institution manager 410, which are described herein. The components can be stored together or in a distributed arrangement.

The client manager 406 can have instructions stored therein that, when executed by the processor(s) 402, enable the financial advisor system 130 to request, confirm, and/or maintain an association with one or more users 104 affiliated with the FLO service system(s) 110. The financial advisor system 130 can be used by a financial advisor to request association with a user 104. Additionally or alternatively, the financial advisor system 130 can be used by the financial advisor 132 to confirm an association requested by a user 104 with the financial advisor. In this way, the financial advisor system 130 can cooperate with the FLO service system 110 to associate a user 104 and his or her financial advisor 132. The financial advisor system(s) 130 can further be able to view the permissions that the financial advisor 132 can be granted by the user 104 with respect to user related data and/or transactions that the financial advisor 132 can have access to and/or make.

The client manager 406 can further have instructions stored therein that, when executed by the processor(s) 402, enable the financial advisor system 130 to display information about all, some, or one user 104 who is affiliated with a particular financial advisor 132. The financial advisor can log-in to his or her financial advisor system 130 and have access to a variety of financial data and/or metrics associated with one or more users 104 who are associated with (e.g., advised by) the financial advisor 132. For example, a financial advisor 132 can be able to view the aggregate cash flow performance and/or FLO score of all of his or her clients. The financial advisor 132, by providing inputs on his or her financial advisor system 130, can still further be able to see cash inflow charts, cash outflow charts, and/or aggregate reservoir flows associated with a group of or individual users 104. The financial advisor 132 can be able to analyze the information about one or more users 104 and classify, label, and/or query financial data associated with the user(s) 104. The financial advisor 132 can further be configured to send and/or receive messages between the financial advisor 132 and his or her affiliated users 104.

The financial data manager 408 can have instructions stored therein that, when executed by the processors 402, enable the financial advisor system 130 to request, from the FLO service system(s) 110, financial transaction data and/or financial metric values associated with users 104 to whom a financial advisor 132 can provide financial advisory services. The financial advisor system 130 can be configured to receive the financial transaction data and/or metric values responsive to the request, and display such information to the financial advisor 132 associated with the financial advisor system 130. In examples, the financial advisor system 130 can also be configured to display a supervisory dashboard which allows for the financial advisor's superiors and/or a compliance department the ability to oversee and/or monitor the financial advisor's activities.

The financial data manager 408 can further include instruction that when executed by processor(s) 402 can enable the financial advisor system 130 to interact with the FLO service system(S) 110 via one or more APIs to receive information about a particular advisor's clients (e.g., users 104 associated with a particular advisor 132). This information may be sent for a collection of user 104 and/or for a particular user 104 based upon inputs from the financial advisor 132 on his or her financial advisor system 130. When an advisor 132 wishes to see information, such as a FLO score and/or cash flow data of a particular user 104 who is a client of the advisor 132, the financial advisor system 130 can receive an input from the financial advisor 132 and, in response, obtain the information about the particular user 104 from the FLO service system(S) 110.

The financial institution manager 410 can have instructions stored therein that, when executed by the processor(s) 402, enable the financial advisor system 130 to interface with one or more financial advisor system(s) 120 to send instructions thereto. These instructions can include requests for more information regarding a particular user 104 and/or instructions to make financial transactions on behalf of the particular user 104. The permissions for this level of access, can in examples, be adjudicated and maintained by the FLO service system(s) 110 based at least in part on permissions granted by a user 104 to his or her financial advisor 132.

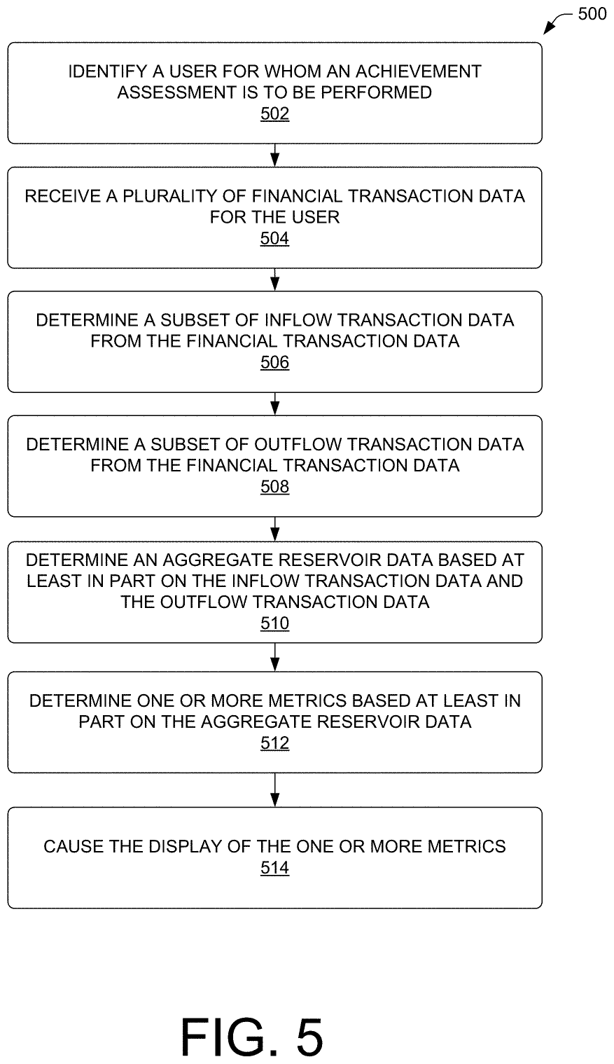

FIGS. 5, 6, 8, 9, and 11 are flow diagrams of illustrative processes illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 5 is a flow diagram of an illustrative method 500 to display one or more metrics associated with a user's aggregate reservoir, according to examples of the disclosure. Method 500 can be performed by the FLO service system(s) 110, in cooperation with one or more other entities of environment 100 of FIG. 1. Of course, the method 500 can be performed in other similar and/or different environments.

At block 502, a user 104 for whom an achievement assessment is to be performed can be identified. The achievement assessment can involve the FLO service system(s) 110 sending one or more financial transaction data and/or financial metric values to a client device 102, which in turn, can be displayed to a user 104 of the client device. The user 104 can, in examples, be identified by a user profile and/or an identifier associated with the user profile. In some cases, the user profile can be identified by conducting an authentication between the client device 102 and the FLO service system(s) 110, where the user 104 can log in to his or her FLO service account, consequently invoking his or her user profile at the FLO service system(s) 110. In some cases, the user 104 can be identified based at least in part on one or more identifiers of the client device 102 corresponding to the user 104, such as a media access control (MAC) identifier, an internet protocol (IP) address, a unique device identifier, or the like.

At block 504, a plurality of financial transaction data for the user can be received. The financial transaction data can be received from the one or more financial institution system(s) 120. In some cases, the financial transaction data can have been previously received and accessed from a datastore, such as financial records datastore 214, that associates the financial transaction data with the user profile of the user 104. In some cases, the financial transaction data can be retrieved from a primary reservoir account, as discussed herein. It should be noted that the financial transaction data can pertain to a particular time period. In some cases, this particular time period can be a default time period (e.g., one month, two weeks, etc.) of the FLO service system(s) 110. In other cases, the particular time period can be a user specified time period and/or a financial advisor specified time period.

At block 506, a subset of inflow transaction data can be determined from the financial transaction data. This can be determined by identifying individual ones of the financial transactions corresponding to the financial transaction data that increase the monetary value of a deposit account or decrease the balance of a debt account. In some cases, if a financial transaction is classified as income of any type, then the corresponding financial transaction data can be classified as an inflow financial transaction data.

At block 508, a subset of outflow transaction data can be determined from the financial transaction data. This can be determined by identifying individual ones of the financial transactions corresponding to the financial transaction data that decrease the monetary value of a deposit account or increase the balance of a debt account. In some cases, if a financial transaction is classified as spending of any type, then the corresponding financial transaction data can be classified as an outflow financial transaction data.

At block 510, an aggregate reservoir data can be determined based at least in part on the inflow transaction data and the outflow transaction data. The aggregate reservoir data can also be the change in a value of an aggregate reservoir, such as a primary reservoir account, or a free cash flow value over a certain time period. This value, in examples, can be determined according to Equation 1, as discussed herein.

At block 512, one or more metrics can be determined based at least in part on the aggregate reservoir data. The one or more metrics can include any suitable metric, such as a FLO score, a FLO score rating, any derivative statistics based thereon, or the like. These metrics can include any suitable metric, such as a FLO score, a FLO score rating, a FLO score moving average, any variety of

In addition to personal financial metrics, the FLO service system(s) 110 can also provide comparisons to other users 104, by making use of its access to a relatively rich set of financial data that lets it determine how a relatively large number of users 104 are performing with respect to their savings. For example, the FLO service system 110 can be configured to provide, for a user 104 of age 43 year old, a comparison of his or her FLO score over a period of time to a distribution of FLO scores of other user 104 between the age of 40 and 45. Such comparisons can help the user 104 visualize his or her savings performance relative to others who can be in a similar life situation, at least from a demographic standpoint.

At block 514, the display of the one or more metrics can be caused. This can entail sending the one or more metric values to a client device 102 associated with the user 104 for whom the one or more metrics are determined at block 512. This transmission of data can be via predefined standards, such as via an API and/or transmission of predefined data structures and/or data files. In alternative embodiments, where the FLOs service system(s) 110 and he client device 102 can operate in a web server-web client relationship, the display can be rendered at the FLO service system(s) 110 and displayed on the client device 102 via a web viewer.

In some examples, a user 104 can have a primary reservoir account to which deposits and/or withdrawals can be made. The FLO service system(s) 110 can obtain financial transaction data from this primary reservoir account and classify the same as inflow, outflow, or transactional. In this way, the FLO service system(s) 110 can retrieve the user's financial transaction data from only one financial institution system 120 associated with the primary reservoir account. By doing so, an aggregate inflow value and an aggregate outflow value can be determined over a particular time period for the user 104, as described herein.

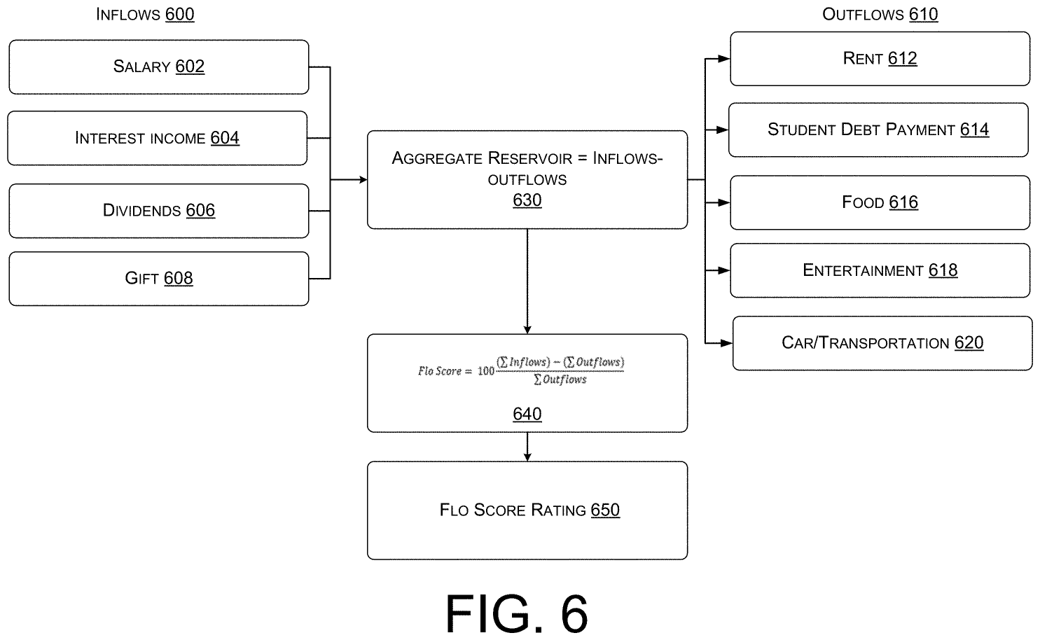

FIG. 6 is a flow diagram of an illustrative mechanism to determine one or more metrics associated with a user's aggregate reservoir 630, according to examples of the disclosure. Method 600 can be performed by the FLO service system(s) 110 in cooperation with one or more other entities of environment 100 of FIG. 1. Of course, the method 600 can be performed in other similar and/or different environments.

There can be a number of financial transaction data that can be considered inflows 600. In this example, salary 602, interest income 604, dividend 606, and gift 608 can be inflows 600. There can also be a number of outflows 610 for the user 104. These outflows can include rent 612, student debt payment 614, food 616, entertainment 618, and car/transportation 620.

From the inflows 600 and outflows 610, an aggregate reservoir value 630 can be calculated. This aggregate reservoir can be equal to the sum of the inflows 600 minus the sum of the outflows. This aggregate reservoir over a particular time period can be referred to as the free cash flow during that time period. A FLO score 640 can be determined based at least in part on the aggregate reservoir value 630, as discussed herein. From the FLO score 640, a FLO score rating 650 can further be determined, as discussed herein.

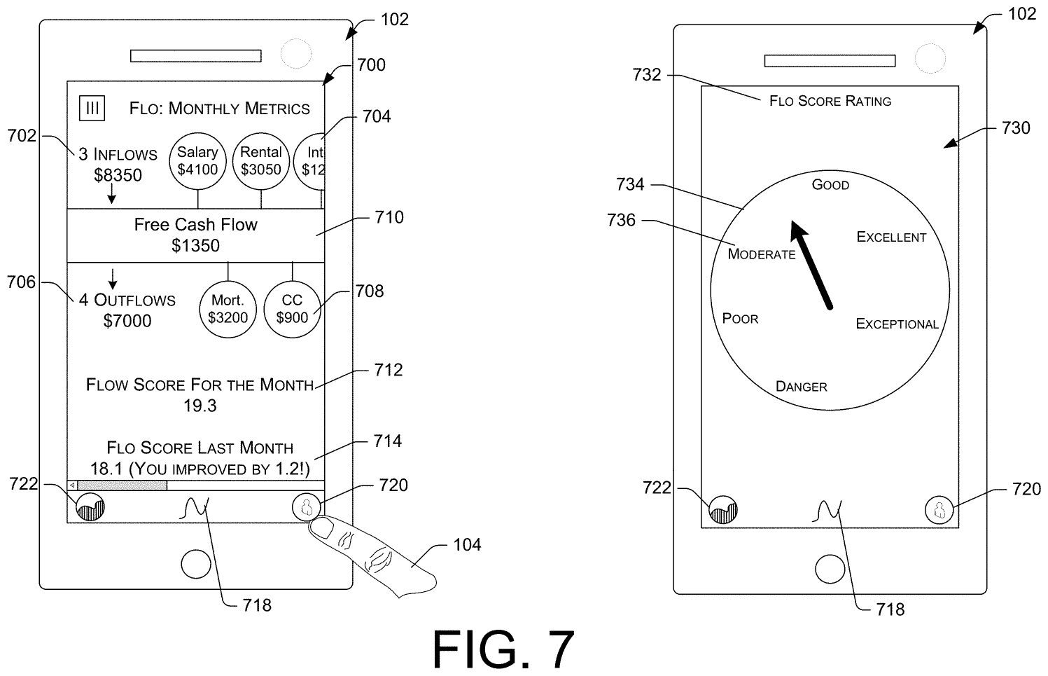

FIG. 7 is a schematic diagram of illustrative client devices 102 where one or more metrics associated with a user's financial situation is displayed, according to examples of the disclosure. The client device 102 can be configured to display interface 700. The display interface 700 can include an indication of an aggregate inflow 702, as well as an indication of individual inflows 704 that can sum to the aggregate inflow 702. Similarly, the display interface 700 can include an indication of an aggregate outflow 706, as well as an indication of individual outflows 708 that can sum to the aggregate outflow 708. The display can also show free cash flow 710 as the difference between the aggregate inflows 702 and the aggregate outflows 706. The display can further show the FLO score 712 corresponding to this user's aggregate inflows 702 and aggregate outflows 706. In some cases, the display interface 700 can still further show one or more statistics associated with the FLO score, such as a change in the FLO score from a previous time period 714.

The display interface 700 can also include one or more input icons 718, 720, 722 selectable by the user 104. These input icons 718, 720, 722 can display other visualizations of the user's financial transaction data and/or financial metrics. The user 104 can select one of the input icons 718, 720, 722 to display his or her financial transactions, FLO score rating, display of his or her continuous FLO score over time, and/or to send messages or instructions to the FLO service system(s) 110 and/or his or her financial advisor 132.

The client device 102 can also be configured to display interface 730. This display interface 730 can be labeled 732 for the user's FLO score rating. A visualization, such as a dial 734, for example, can be displayed to show the FLO score rating corresponding to the user 104. As discussed herein, the FLO score rating can be a set of descriptors 736 of one's savings performance as determined from his or her FLO score during a particular time period.

It should be noted that FIG. 7 provides some example interfaces 700, 730, such as graphical user interfaces (GUI), and is not meant to be a comprehensive description of interfaces or limiting in how financial transaction data and/or financial metrics are displayed to a user on his or her client device 102.

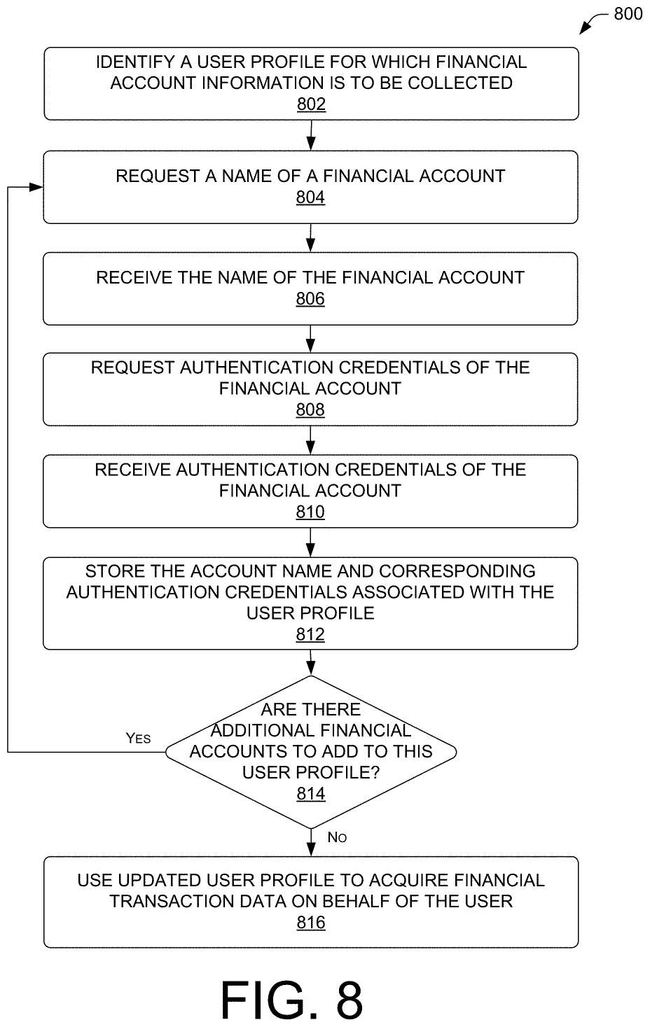

FIG. 8 is a flow diagram of an illustrative method 800 to set up a user's financial data feed from one or more financial institutions, according to examples of the disclosure. Method 800 can be performed by the FLO service system(s) 110 in cooperation with one or more other entities of environment 100 of FIG. 1. Of course, the method 800 can be performed in other similar and/or different environments.

At block 802, a user profile for which financial account information is to be collected can be identified. In some cases, the user profile can be identified by conducting an authentication between the client device 102 and the FLO service system(s) 110, where the user 104 can log in to his or her account, and consequently invoking his or her user profile at the FLO service system(s) 110. In some cases, the user 104 can be identified based at least in part on one or more identifiers of the client device 102 corresponding to the user 104, such as a media access control (MAC) identifier, an internet protocol (IP) address, a unique device identifier, or the like.

At block 804, a name of a financial account can be requested. This request can be in the form of a field on a graphical user interface (GUI) as caused to be displayed on the client device 102 by the FLO service system(s) 110. Any other suitable mechanism to solicit the name of the financial account can also be used, such as a command line entry. At block 806, the name of the financial account can be received. The user 104 can enter the financial account name on his or her client device 102 running the FLO application thereon, and the client device 102 can send this information to the FLO service system(s) 110.

At block 808, authentication credentials of the financial account can be requested. Again, this request can be in the form of a field on a GUI as caused to be displayed on the client device 102 by the FLO service system(s) 110. Any other suitable mechanism to solicit the name of the financial account can also be used, such as a command line entry. At block 810, the authentication credential of the financial account can be received. The user 104 can enter the authentication credentials on his or her client device 102 running the FLO application thereon, and the client device 102 can send this information to the FLO service system(s) 110. In examples, other access enabling elements can also be provided by the client device 104 to the FLO service system(s) 110, such as authentication certificates based on shared-key and/or public-private key infrastructure (PM).

At block 812, the financial account name and corresponding authentication credentials can be stored in association with the user profile. This information can be stored, as linked with the user profile of the user 104, for access later on to access individual ones of the user's financial accounts at various financial account system(s) 120. At block 814, it can be determined if there are any additional accounts to add to this user profile. This can be determined by inquiry to the user 104 via his or her client device and FLO application operating thereon. The user can provide the response as to whether there is additional financial account information to be added to his or her user profile. If there is additional financial account information to be added to the user profile, then the method can return to block 804 to obtain that financial account information.

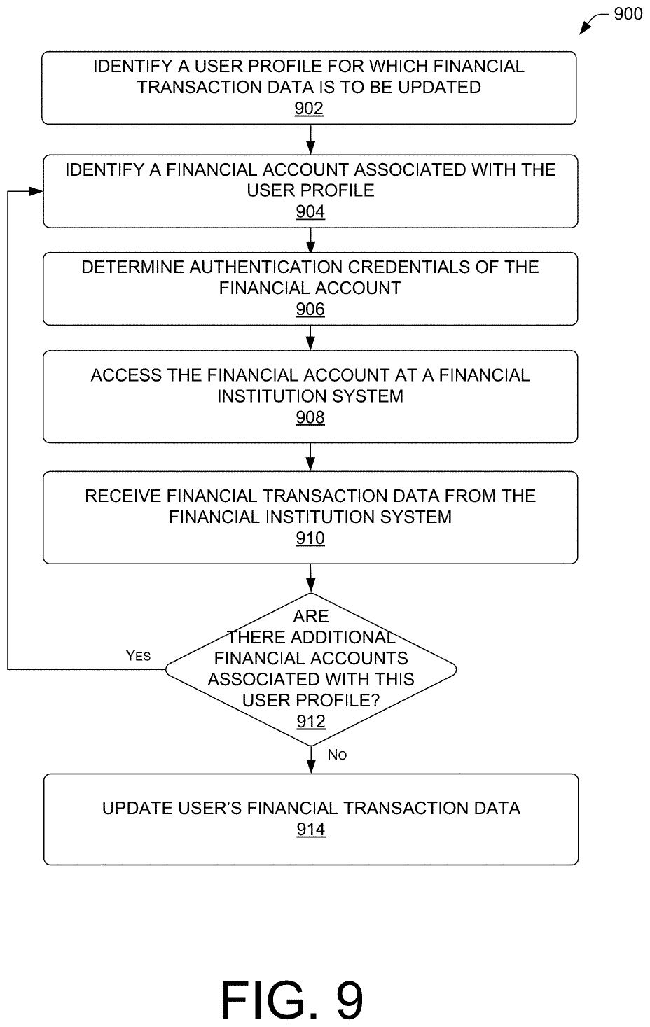

If it is determined at block 814 that there is no further financial account information to be collected for the user 104, then at block 816, the updated user profile can be used to acquire financial transaction data on behalf of the user. This procedure can occur asynchronously by the FLO service system(s) 110 pulling the financial transaction data from individual ones of the financial institution system(s) 120. An example asynchronous mechanism for obtaining user 104 financial transaction data is discussed below in conjunction with FIG. 9. Alternatively, the acquisition of the financial transaction data of users 104 can occur synchronously or near synchronously, as financial transaction take place.

FIG. 9 is a flow diagram of an illustrative method 900 to receive a user's financial transaction data from one or more financial institutions, according to examples of the disclosure. Method 900 can be performed by the FLO service system(s) 110 in cooperation with one or more other entities of environment 100 of FIG. 1. Of course, the method 900 can be performed in other similar and/or different environments.

At block 902, a user profile for which financial transaction data is to be updated can be identified. In some cases, the user profile can be identified by conducting an authentication between the client device 102 and the FLO service system(s) 110, where the user 104 can log in to his or her account, and consequently invoking his or her user profile at the FLO service system(s) 110. In some cases, the user 104 can be identified based at least in part on one or more identifiers of the client device 102 corresponding to the user 104, such as a media access control (MAC) identifier, an internet protocol (IP) address, a unique device identifier, or the like.

At block 904, an account associated with the user profile can be identified. This financial account can be determined from the associations of financial account names and authentication credentials with the user profile, as established by any suitable mechanism, such as by the example method 800 of FIG. 8. At block 906, authentication credentials of the account can be determined. These authentication credentials (e.g., login, password, PM certificate, secondary authentications, two-factor authentication, secondary password, etc.) can be identified from the user profile of the user 104. At block 908, the financial account can be accessed at a financial institution system. This access can be on behalf of the user 104, by the FLO service system(s) 110 using the user's authentication credentials.

At block 910, financial transaction data can be received from the financial institution system. This financial transaction data can be received responsive to the FLO service system(s) 110 requesting the same using the user's authentication credentials to access the financial account. At block 912, it can be determined if there are any additional accounts associated with this user profile. If it is determined that there is at least one additional account associated with this user profile, then the method 900 can return to block 904 to access the next account and receive financial transaction data therefrom. On the other hand, if it is determined at block 912 that there are no further accounts associated with the user profile, then the method 900 can proceed to block 914, where the user's transaction data can be updated.

It should be understood that in some examples, the FLO service system(s) 110 can establish communications with a particular financial institution system 120 and download all of the financial transaction data for all users 104 who are both associated with that particular financial institutions system 120, as well as the FLO service system(s) 110. As the financial transaction data is received for individual users 104, that data can be sorted by user profiles and stored in association with their corresponding user profile. The FLO service system(s) 110 can then repeat the same procedure with the next financial institution system 120. This process can continue until all the financial transaction data for all users 104 associated with the FLO service system(s) 110 has been obtained and sorted by user profile.

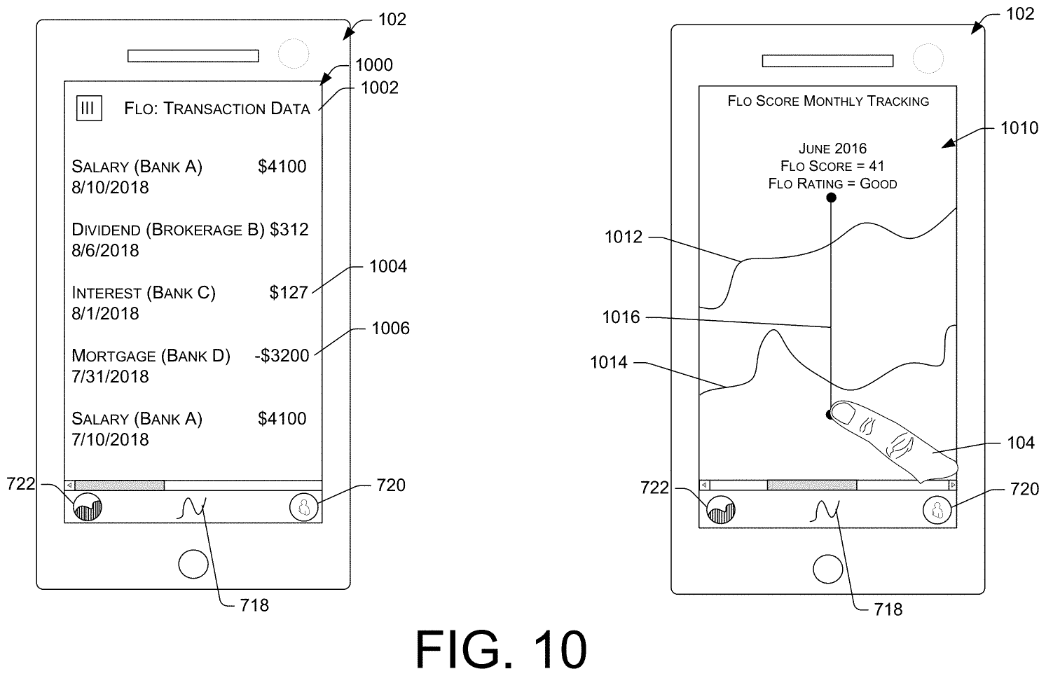

FIG. 10 is a schematic diagram of illustrative client devices 102 that display financial transaction data and tracking over time of financial transaction data and/or financial metrics, according to examples of the disclosure. The client device 102 can display interface 1000 to display financial transaction data 1002 over a particular time period. The time period can be a default time period or a user selected time period. The user's financial transaction data 1002 can be acquired by the operations of method 900 of FIG. 9 to be displayed to the user 104 on his or her client device 102.

The client device 102 can further display interface 1010 to display financial metrics over time as selected by the user 104. For example, the display interface 1010 can show inflows 1012 over time, outflows 1014 over time, and free cash flow 1016 over time, as the difference between the inflows 1012 and the outflows 1014. The display interface 1010 can also show the FLO score, FLO score rating, and/or any other suitable statistic pertaining to the user's savings performance.

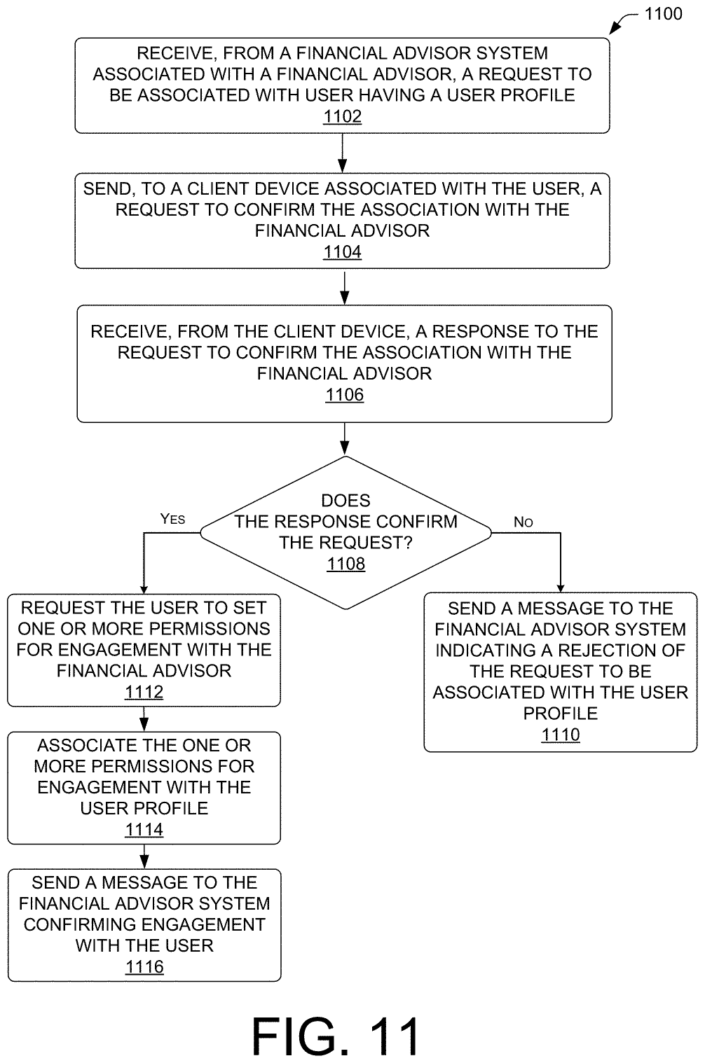

FIG. 11 is a flow diagram of an illustrative method to enable a user to engage a financial advisor, according to examples of the disclosure.

Method 1100 can be performed by the FLO service system(s) 110 in cooperation with one or more other entities of environment 100 of FIG. 1. Of course, the method 1100 can be performed in other similar and/or different environments.

At block 1102, a request to be associated with a user 104 having a user profile can be received from a financial advisor system 130. This request can originate from a financial advisor 132 having his or her own advisor account with the FLO service system(s) 110 requesting association, via their financial advisor system 103, with the user 104 to provide financial planning services to that user 104.

At block 1104, a request to confirm the association with the financial advisor 132 can be sent to the client device 102 of the user 104. In this way, the user 104 is given agency in approving or disapproving his or her associations. At block 1106, a response to the request for confirmation can be received from the client device 102. At block 1108, it can be determined where the user 104 confirms the request for association.

If it is determined, at block 1108 that the user 104 does not confirm the association with the financial advisor 132, then at block, a message can be sent indicating the rejection of the confirmation. In other words, the financial advisor 132, via his or her financial advisor system 130, can be notified that the user 104 does not wish to be associated with him or her. On the other hand, if the response, at block 1108, confirms the user's wish to be associated with the financial advisor 132, then at block 1112, the FLO service system(s) 110 can request the user 104 to set one or more permissions for engagement with the financial advisor 132 at block 1112. At block 1114, the one or more permissions as indicated by the user 104 can be set for the financial advisor 132. This can allow the financial advisor some access (e.g., see financial metrics of the user 104), but not others (e.g., perform financial transactions on behalf of the user 104), for example, as stipulated by the user 104. At block 1116, a message can be sent to the financial advisor system 132 confirming engagement with the user 104. Optionally, an indication of the permissions set by the user 104, can also be sent to the financial advisor system 130.

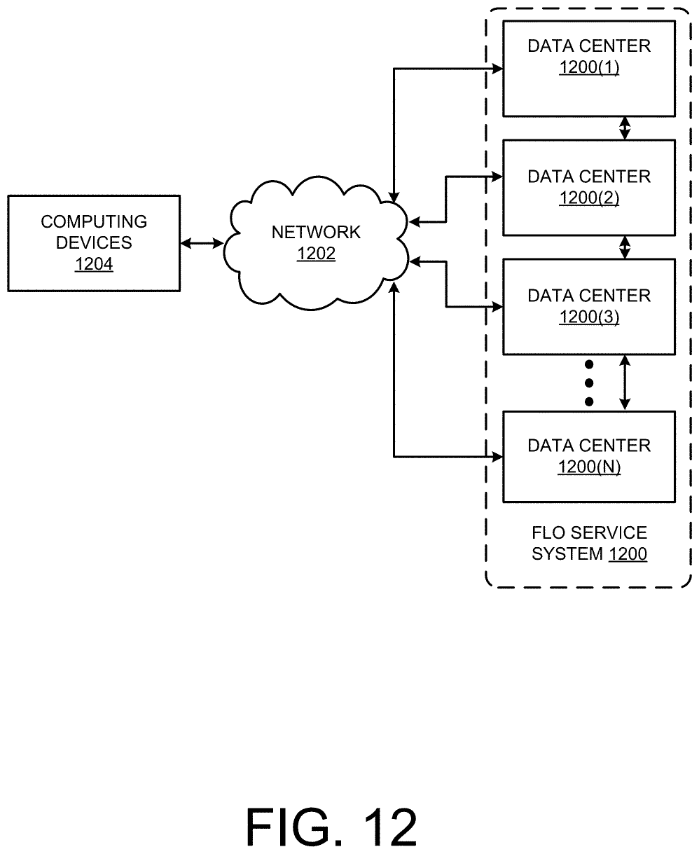

FIG. 12 is a system and network diagram that shows an illustrative operating environment that includes a FLO service system 1200 that can be configured to implement aspects of the functionality described herein, according to examples of the disclosure. As discussed briefly above, the system 1200 can execute application testing services, such as generating test scripts. Among other types of functionality, the computing resources provided by the system, or by a larger system of which the system is a part, can be utilized to implement the various application testing services described herein. As also discussed above, the system can be part of a larger system that provides the additional computing resources that include, without limitation, data storage resources, data processing resources, such as virtual machine (VM) instances, networking resources, data communication resources, network services, and other types of resources.

Each type of computing resource provided by system, or by a larger system of which the system is a part, can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The system, or a larger system of which the system is a part, can also be configured to provide other types of computing resources not mentioned specifically herein.

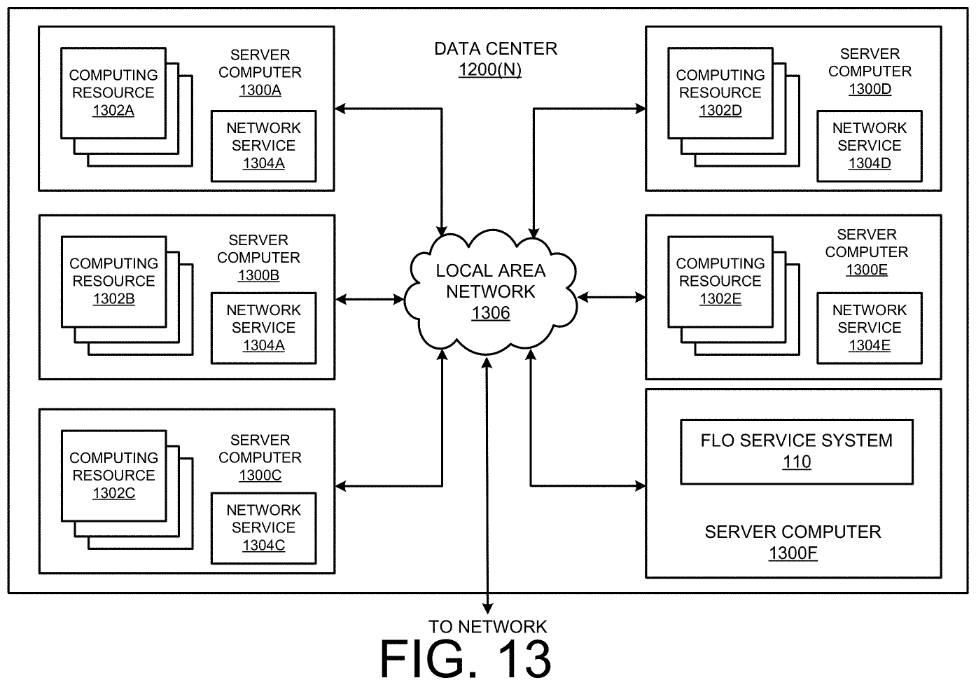

The computing resources provided by system, or a larger system of which the system is a part, are enabled in one implementation by one or more data centers 1200(1), 1200(2), 1200(3), . . . , 1200(N). The data centers are facilities utilized to house and operate computer systems and associated components. The data centers typically include redundant and backup power, communications, cooling, and security systems. The data centers can also be located in geographically disparate locations. One illustrative configuration for a data center that can be utilized to implement the technologies disclosed herein will be described below with regard to FIG. 13.

The users of the system can access the computing resources, such as the FLO service system(s) 110, provided by the system over a network 1202, which can be a wide area communication network (“WAN”), such as the Internet, an intranet or an Internet service provider (“ISP”) network or a combination of such networks. For example, and without limitation, a computing device 1204 (e.g., the client device 102) operated by a user of the system can be utilized to access the system by way of the network 1202. It should be appreciated that a local-area network (“LAN”), the Internet, or any other networking topology known in the art that connects the data centers to remote users and other users can be utilized. It should also be appreciated that combinations of such networks can also be utilized.

FIG. 13 is a computing system diagram illustrating a configuration for a data center 1200(N) that can be utilized to implement aspects of the technologies disclosed herein, according to examples of the disclosure.

These technologies can include the FLO service system(s) 110. The example data center 1200(N) shown in FIG. 13 includes several server computers 1300A-1300F (collectively 1300) for providing the computing resources 1302A-1302E (collectively 1002), respectively.

The server computers 1300 can be standard tower, rack-mount, or blade server computers configured appropriately for providing the various computing resources described herein (illustrated in FIG. 13 as the computing resources 1302A-1302E). As mentioned above, the computing resources 1302 provided by the system, or a larger system of which the system is a part, can include, without limitation, analytics applications, data storage resources, data processing resources such as VM instances or hardware computing systems, database resources, networking resources, and others. Some of the servers 1300 can also be configured to execute network services 1304A-1304E (collectively 1304) capable of instantiating, providing and/or managing the computing resources 1302, some of which are described in detail herein.

The data center 1200(N) shown in FIG. 13 also includes a server computer 1300F that can execute some or all of the software components described above. For example, and without limitation, the server computer 1300F can be configured to execute the FLO service system(s) 110. The server computer 1300F can also be configured to execute other components and/or to store data for providing some or all of the functionality described herein. In this regard, it should be appreciated that components or different instances of the FLO service system(s) 110 can execute on many other physical or virtual servers in the data centers 1200 in various configurations.

In the example data center 1200(N) shown in FIG. 13, an appropriate LAN 1306 is also utilized to interconnect the server computers 1300A-1300F. The LAN 1306 is also connected to the network 1202 illustrated in FIG. 12. It should be appreciated that the configuration of the network topology described herein has been greatly simplified and that many more computing systems, software components, networks, and networking devices can be utilized to interconnect the various computing systems disclosed herein and to provide the functionality described above.

Appropriate load balancing devices or other types of network infrastructure components can also be utilized for balancing a load between each of the data centers 1200(1)-(N), between each of the server computers 1300A-1300F in each data center 1200, and, potentially, between computing resources 1302 in each of the data centers 1200. It should be appreciated that the configuration of the data center 1200 described with reference to FIG. 13 is merely illustrative and that other implementations can be utilized.

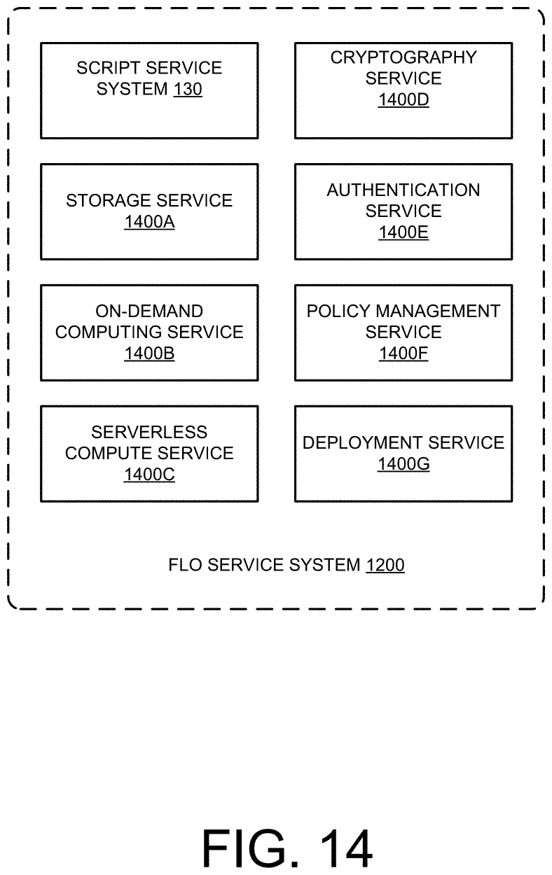

FIG. 14 is a network services diagram that shows aspects of several services that can be provided by and utilized within a system, or a larger system of which the system is a part, which is configured to implement the various technologies disclosed herein, according to examples of the disclosure.

In particular, and as discussed above, the system, or a larger system of which the system is a part, can provide a variety of network services to users and other users including, but not limited to, the FLO service system(s) 110, a storage service 1400A, an on-demand computing service 1400B, a serverless compute service 1400C, a cryptography service 1400D, an authentication service 1400E, a policy management service 1400F, and a deployment service 1400G. The system, or a larger system of which the system is a part, can also provide other types of network services, some of which are described below.

It is also noted that not all configurations described include the network services shown in FIG. 14 and that additional network services can be provided in addition to, or as an alternative to, the services explicitly described herein. Each of the services shown in FIG. 14 can also expose web service interfaces that enable a caller to submit appropriately configured API calls to the various services through web service requests. The various web services can also expose GUIs, command line interfaces (“CLIs”), and/or other types of interfaces for accessing the functionality that they provide. In addition, each of the services can include service interfaces that enable the services to access each other. Additional details regarding some of the services shown in FIG. 14 will now be provided.

The storage service 1400A can be a network-based storage service that stores data obtained from users of the system, or a larger system of which the system is a part. The data stored by the storage service 1400A can be obtained from computing devices of users.

The on-demand computing service 1400B can be a collection of computing resources configured to instantiate VM instances and to provide other types of computing resources on demand. For example, a user of the system, or a larger system of which the system is a part, can interact with the on-demand computing service 1400B (via appropriately configured and authenticated API calls, for example) to provision and operate VM instances that are instantiated on physical computing devices hosted and operated by the system, or a larger system of which the system is a part. The VM instances can be used for various purposes, such as to operate as servers supporting the network services described herein, a web site, to operate business applications or, generally, to serve as computing resources for the user.

Other applications for the VM instances can be to support database applications, electronic commerce applications, business applications and/or other applications. Although the on-demand computing service 1400B is shown in FIG. 14, any other computer system or computer system service can be utilized in the system, or a larger system of which the system is a part, to implement the functionality disclosed herein, such as a computer system or computer system service that does not employ virtualization and instead provisions computing resources on dedicated or shared computers/servers and/or other physical devices.

The serverless compute service 1400C is a network service that allows users to execute code (which might be referred to herein as a “function”) without provisioning or managing server computers in the system, or a larger system of which the system is a part. Rather, the serverless compute service 1400C can automatically run code in response to the occurrence of events. The code that is executed can be stored by the storage service 1400A or in another network accessible location.

In this regard, it is to be appreciated that the term “serverless compute service” as used herein is not intended to infer that servers are not utilized to execute the program code, but rather that the serverless compute service 1400C enables code to be executed without requiring a user to provision or manage server computers. The serverless compute service 1400C executes program code only when needed, and only utilizes the resources necessary to execute the code. In some configurations, the user or entity requesting execution of the code might be charged only for the amount of time required for each execution of their program code.

The system, or a larger system of which the system is a part, can also include a cryptography service 1400D. The cryptography service 1400D can utilize storage services of the system, or a larger system of which the system is a part, such as the storage service 1400A, to store encryption keys in encrypted form, whereby the keys can be usable to decrypt user keys accessible only to particular devices of the cryptography service 1400D. The cryptography service 1400D can also provide other types of functionality not specifically mentioned herein.

The system, or a larger system of which the system is a part, in various configurations, also includes an authentication service 1400E and a policy management service 1400F. The authentication service 1400E, in one example, is a computer system (i.e., collection of computing resources 1302) configured to perform operations involved in authentication of users or customers. For instance, one of the services shown in FIG. 14 can provide information from a user or customer to the authentication service 1400E to receive information in return that indicates whether or not the requests submitted by the user or the customer are authentic.

The policy management service 1400F, in one example, is a network service configured to manage policies on behalf of users or customers of the system, or a larger system of which the system is a part. The policy management service 1400F can include an interface (e.g. API or GUI) that enables customers to submit requests related to the management of policy, such as a security policy. Such requests can, for instance, be requests to add, delete, change or otherwise modify policy for a customer, service, or system, or for other administrative actions, such as providing an inventory of existing policies and the like.

The system, or a larger system of which the system is a part, can additionally maintain other network services based, at least in part, on the needs of its customers. For instance, the system, or a larger system of which the system is a part, can maintain a deployment service 1400G for deploying program code in some configurations. The deployment service 1400G provides functionality for deploying program code, such as to virtual or physical hosts provided by the on-demand computing service 1400B. Other services include, but are not limited to, database services, object-level archival data storage services, and services that manage, monitor, interact with, or support other services. The system, or a larger system of which the system is a part, can also be configured with other network services not specifically mentioned herein in other configurations.

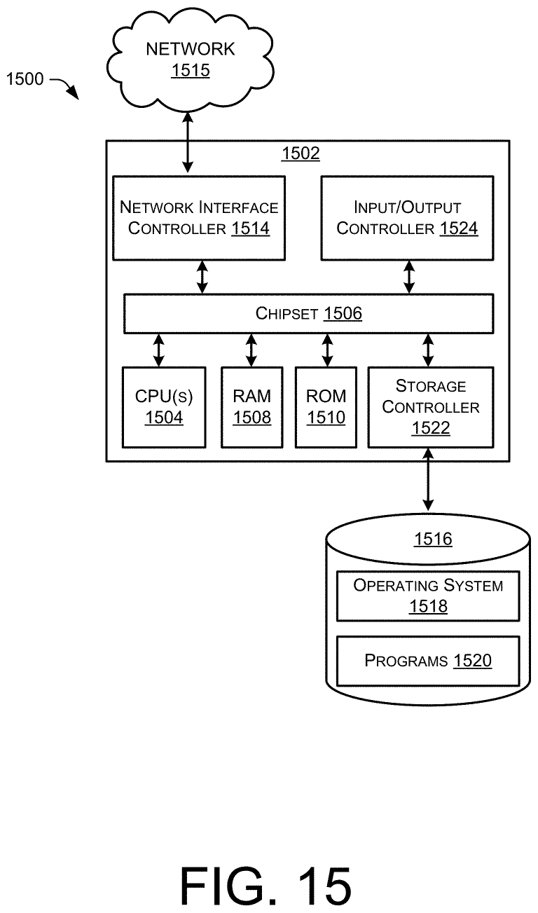

FIG. 15 is a computer architecture diagram showing an illustrative computer hardware architecture for implementing a computing device that can be utilized to implement aspects of the various technologies presented herein, according to examples of the disclosure. The computer architecture shown in FIG. 15 illustrates a conventional server computer, workstation, desktop computer, laptop, tablet, network appliance, e-reader, smartphone, or other computing device, and can be utilized to execute any of the software components presented herein. The computer 1500 can represent architecture for a naming service, a concentrator, a reader, and/or other devices described herein.

The computer 1500 includes a baseboard 1502, or “motherboard,” which is a printed circuit board to which a multitude of components or devices can be connected by way of a system bus or other electrical communication paths. In one illustrative configuration, one or more central processing units (“CPUs”) 1504 operate in conjunction with a chipset 1506. The CPUs 1504 can be standard programmable processors that perform arithmetic and logical operations necessary for the operation of the computer 1500.

The CPUs 1504 perform operations by transitioning from one discrete, physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1506 provides an interface between the CPUs 1504 and the remainder of the components and devices on the baseboard 1502. The chipset 1506 can provide an interface to a RAM 1508, used as the main memory in the computer 1500. The chipset 1506 can further provide an interface to a computer-readable storage medium such as a read-only memory (“ROM”) 1510 or non-volatile RAM (“NVRAM”) for storing basic routines that help to startup the computer 1500 and to transfer information between the various components and devices. The ROM 1510 or NVRAM can also store other software components necessary for the operation of the computer 1500 in accordance with the configurations described herein.

The computer 1500 can operate in a networked environment using logical connections to remote computing devices and computer systems through a network, such as the network 1512. The chipset 1506 can include functionality for providing network connectivity through a NIC 1514, such as a gigabit Ethernet adapter. The NIC 1514 is capable of connecting the computer 1500 to other computing devices over the network 1512. It should be appreciated that multiple NICs 1514 can be present in the computer 1500, connecting the computer to other types of networks and remote computer systems.

The computer 1500 can be connected to a mass storage device 1516 that provides non-volatile storage for the computer. The mass storage device 1516 can store an operating system 1518, programs 1520, and data, which have been described in greater detail herein. The mass storage device 1516 can be connected to the computer 1500 through a storage controller 1522 connected to the chipset 1506. The mass storage device 1516 can consist of one or more physical storage units. The storage controller 1522 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1500 can store data on the mass storage device 1516 by transforming the physical state of the physical storage units to reflect the information being stored. The specific transformation of physical state can depend on various factors, in different implementations of this description. Examples of such factors can include, but are not limited to, the technology used to implement the physical storage units, whether the mass storage device 1516 is characterized as primary or secondary storage, and the like.

For example, the computer 1500 can store information to the mass storage device 1516 by issuing instructions through the storage controller 1522 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1500 can further read information from the mass storage device 1516 by detecting the physical states or characteristics of one or more particular locations within the physical storage units.

In addition to the mass storage device 1516 described above, the computer 1500 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 1500.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the mass storage device 1516 can store an operating system 1518 utilized to control the operation of the computer 1500. According to one configuration, the operating system comprises the LINUX operating system or one of its variants such as, but not limited to, UBUNTU, DEBIAN, and CENTOS. According to another configuration, the operating system comprises the WINDOWS SERVER operating system from MICROSOFT Corporation. According to further configurations, the operating system can comprise the UNIX operating system or one of its variants. It should be appreciated that other operating systems can also be utilized. The mass storage device 1516 can store other system or application programs and data utilized by the computer 1500.

In one configuration, the mass storage device 1516 or other computer-readable storage media is encoded with computer-executable instructions which, when loaded into the computer 1500, transform the computer from a general-purpose computing system into a special-purpose computer capable of implementing the configurations described herein. These computer-executable instructions transform the computer 1500 by specifying how the CPUs 1504 transition between states, as described above. According to one configuration, the computer 1500 has access to computer-readable storage media storing computer-executable instructions which, when executed by the computer 1500, perform the various processes described above. The computer 1500 can also include computer-readable storage media for performing any of the other computer-implemented operations described herein.

The computer 1500 can also include one or more input/output controllers 1524 for receiving and processing input from a number of input devices, such as a keyboard, a mouse, a touchpad, a touch screen, an electronic stylus, or other type of input device. Similarly, an input/output controller 1524 can provide output to a display, such as a computer monitor, a flat-panel display, a digital projector, a printer, or other type of output device. It will be appreciated that the computer 1500 might not include all of the components shown in FIG. 15, can include other components that are not explicitly shown in FIG. 15, or can utilize an architecture completely different than that shown in FIG. 15.

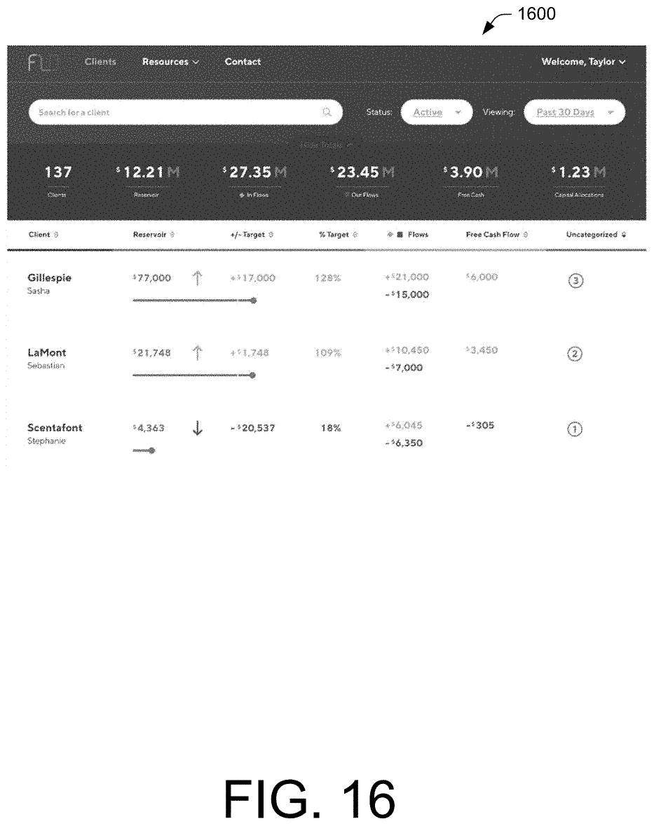

FIG. 16 is a schematic diagram of an illustrative user interface 1600 displayed on a financial advisor system 130 showing user financial data for a plurality of users 104 over a particular time frame, according to examples of the disclosure. As shown, the financial advisor 132 can be “Taylor.” The financial advisor 132 can be logged into his or her FLO account on the FLO service system(s) 110 via his or her financial advisor system 130. This login procedure can involve authentication by the FLO service system(s) 110 of the financial advisor's financial advisor profile, such as by using a login name and password.

Once the financial advisor 132 is logged in, the FLO service system(s) 110 can be configured to identify the users 104 who are associated with the financial advisor profile. In other words, the FLO service system(s) 110 can be able to identify the users 104 who are clients of the financial advisor 132. Financial data (e.g., financial transactions, financial metrics, etc.) associated with the users 104 associated with the financial advisor 132 can be identified by the FLO service system(s) 110 and sent to the financial advisor system 130. The financial advisor system 130, by running the FLO software running thereon, can display an indication of the financial advisor's associated users 104 (e.g., clients). For example, as shown, the FLO service system(s) 110 can identify that users “Sasha Gillespie,” “Sebastian LaMont,” and “Stephanie Scentafont” are associated with the financial advisor Taylor, who has logged in to the FLO service system(s) 110 via his or her financial advisor system 130.

When the financial advisor 132 logs into his or her financial advisor account, he or she can be able to see information about all of his clients. For example, he or she may see the total number of clients (e.g., 137), information about his or her clients over a particular time period (e.g., previous 30 days), total reservoir for all of his or her clients (e.g., $12.21 million), total inflows for all of his or her clients (e.g., $27.35 million) over the time period, outflows for all of his or her clients (e.g., $23.45 million) over the time period, free cash flow for all of his or her clients (e.g., $3.90 million) over the time period, capital allocations for all of his or her clients (e.g., $1.23 million) over the time period, or the like.

The financial advisor 132 can also be able to select one or more of his or her clients, as displayed on his or her financial advisor system 130 to see, generate, and/or interact with financial data pertaining to particular client(s). The financial advisor 132 can also be able to change the time period over which he or she views data for one or more of his clients. The financial advisor 132 can be able to view summary financial information regarding his or her clients. This summary financial information can include, for example, a reservoir amount, performance of the reservoir relative to a target, the reservoir as a percentage of the target, cash flows (e.g., inflows and outflows), free cash flow, and categories of cash flows, or the like. The financial advisor can be able to select (e.g., click on a client name) to access more detailed information about that user 104.

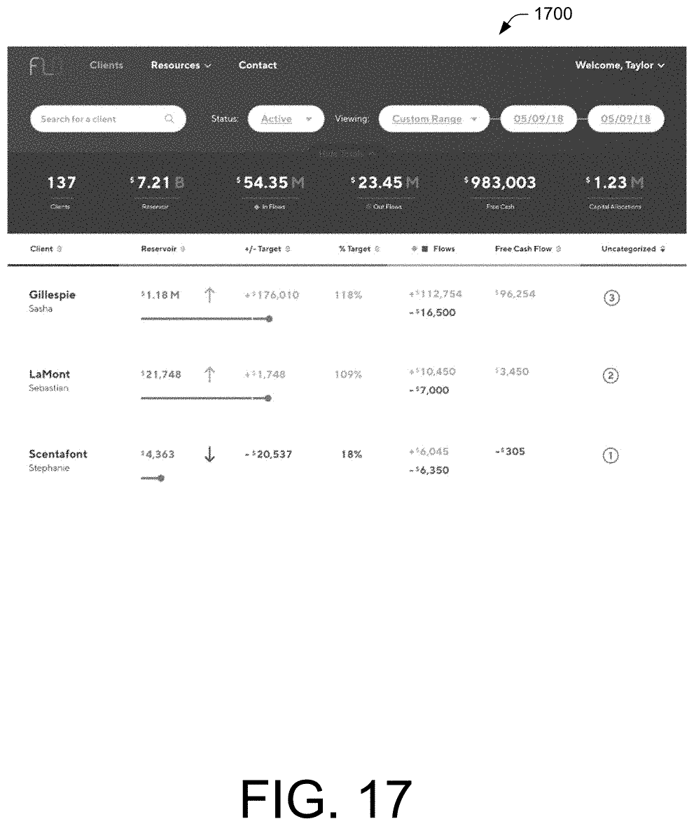

FIG. 17 is a schematic diagram of an illustrative user interface 1700 displayed on a financial advisor system 130 showing user financial data for a plurality of users 104 over a time frame that is different from the time frame of FIG. 16, according to examples of the disclosure. As a result, of the different time frame, the financial data and/or metrics associated with the collection of clients of this financial advisor 132 can be different than those in FIG. 16. The financial data associated with each of the users 104 displayed also can pertain to the date range selected by the financial advisor 132 by way of his or her financial advisor system 130.

When a date range is changed by user input, such as by the financial advisor 132 on his or her financial advisor system 130, the financial advisor system can query a new set of financial information and/or financial metrics from the FLO service system(s) 110 pertaining to the date range selected. The FLO service system(s) 110 can send the new financial data and/or financial metric values corresponding to the new date ranges, as selected by the financial advisor 132. The financial advisor system 130 can receive the new financial data and/or financial metric values as sent by the FLO service system(s) 110, and display this information on the financial advisor system 130.

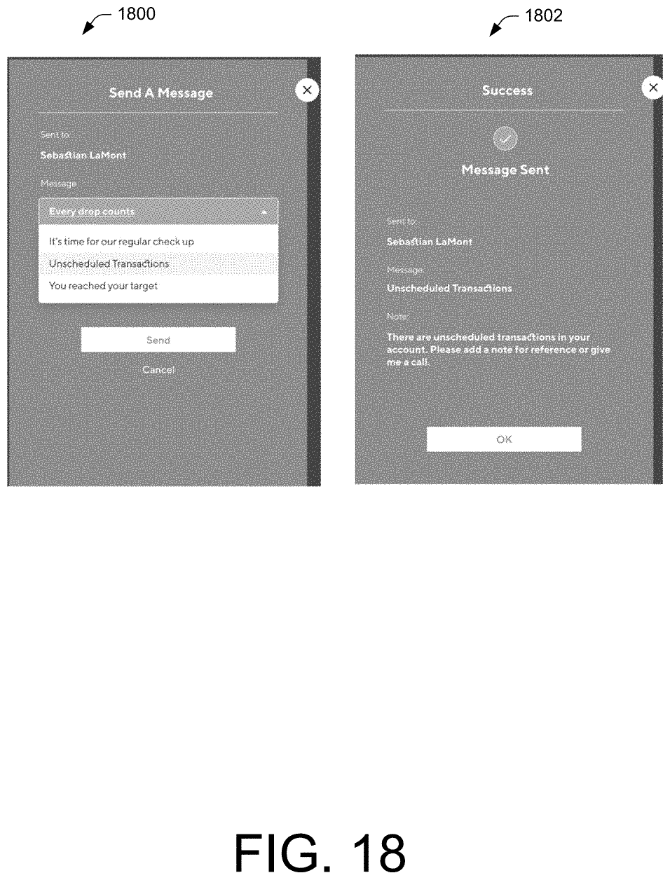

FIG. 18 is a schematic diagram of illustrative user interfaces 1800, 1802 displayed on a financial advisor system 130 for sending a message 138 to a particular user 104, according to examples of the disclosure. In this case, the financial advisor 132 can send the message 138 to one of his clients, “Sebastian LaMont.” Thus, the software operating on the financial advisor system 130 can be capable of providing an interface 1800, 1802 where the financial advisor can enter and/or write a message to one or more of his or her clients, such as within the FLO application, which can then be sent to the FLO service system(s) 100 forwarding to the recipient user 104 via his or her client device 102.

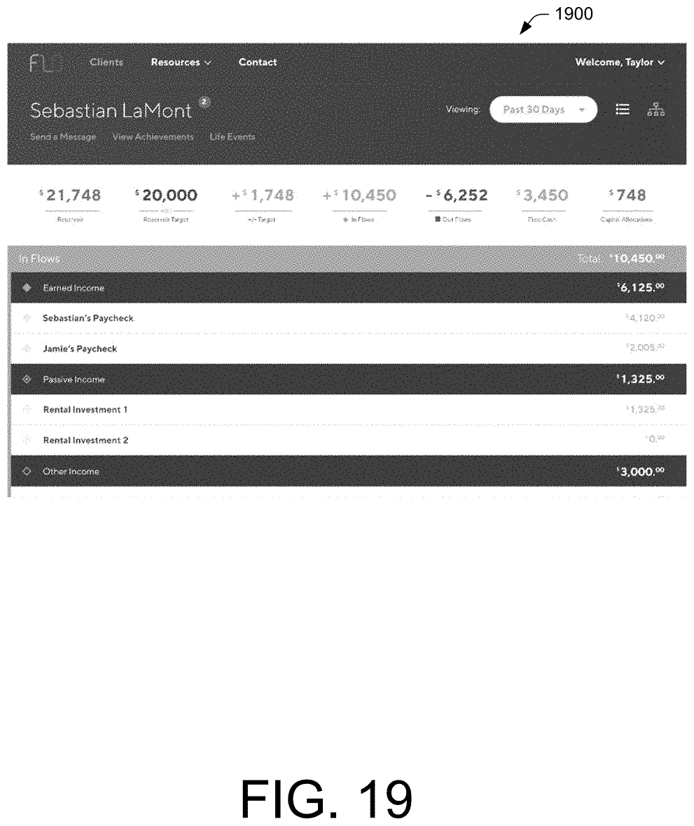

FIG. 19 is a schematic diagram of an illustrative user interface 1900 displayed on a financial advisor system 130 showing financial information of a user 104, according to examples of the disclosure. This financial information can show the user's inflows (e.g., earned income, passive income, etc.) over a time period (e.g., 30 days). Thus, the financial advisor can have convenient access to the user's 104 financial activities and can advise the user 104 accordingly. The financial advisor 132 can be able to change the time frames on the user interface 1900 to see the user's financial activities over different time frames.

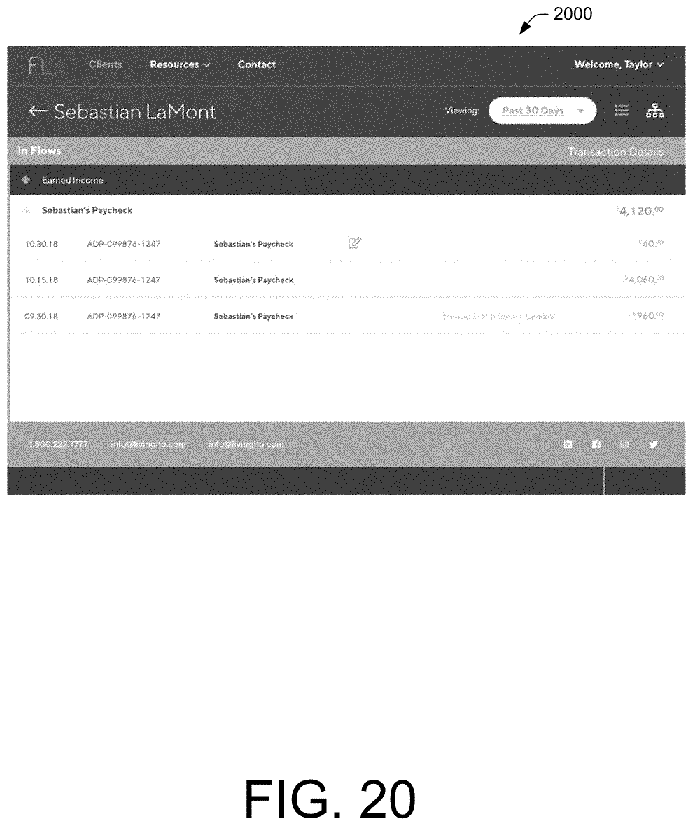

FIG. 20 is a schematic diagram of an illustrative user interface 2000 displayed on a financial advisor system 130 showing cash inflow financial information from earned income of the user 104 of FIG. 19, according to examples of the disclosure. As shown, various sources of the user's earned income can be viewed by the financial advisor 132. The financial advisor 132 can be able to provide advice based at least in part on the user's earned income information, such as by sending a message 138 to the user 104 via his or her financial advisor system 130. Again, the time period over which financial data for the user 104 is displayed can be changed by the financial adviser 132, and responsive to such change, the financial advisor system 130 and the FLO service system(s) 110 can cooperate to provide the financial data and/or metrics requested by the financial advisor 132.

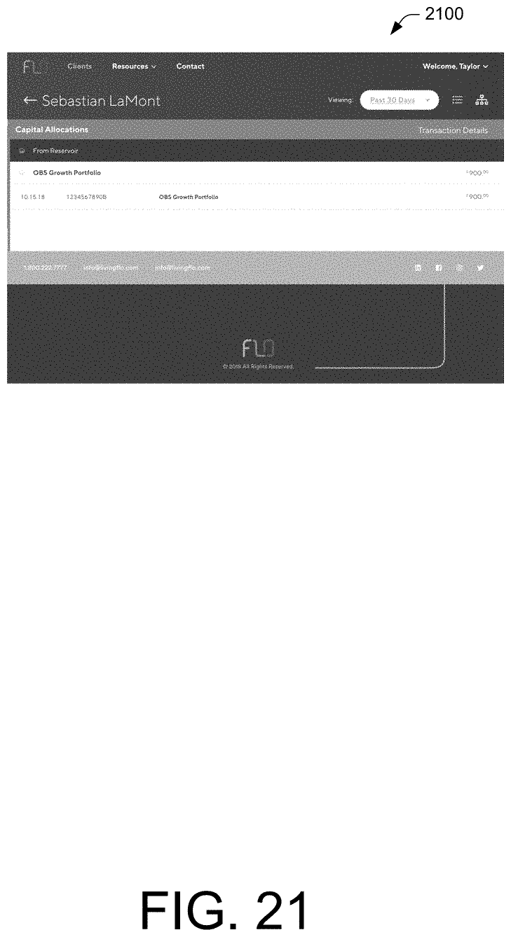

FIG. 21 is a schematic diagram of an illustrative user interface 2100 displayed on a financial advisor system 130 showing capital allocations of the user 104 of FIG. 19, according to examples of the disclosure. The capital allocation can be from a reservoir account into a particular investment. Again, the time period over which financial data for the user 104 is displayed can be changed by the financial adviser 132, and responsive to such change, the financial advisor system 130 and the FLO service system(s) 110 can cooperate to provide the financial data and/or metrics requested by the financial advisor 132.

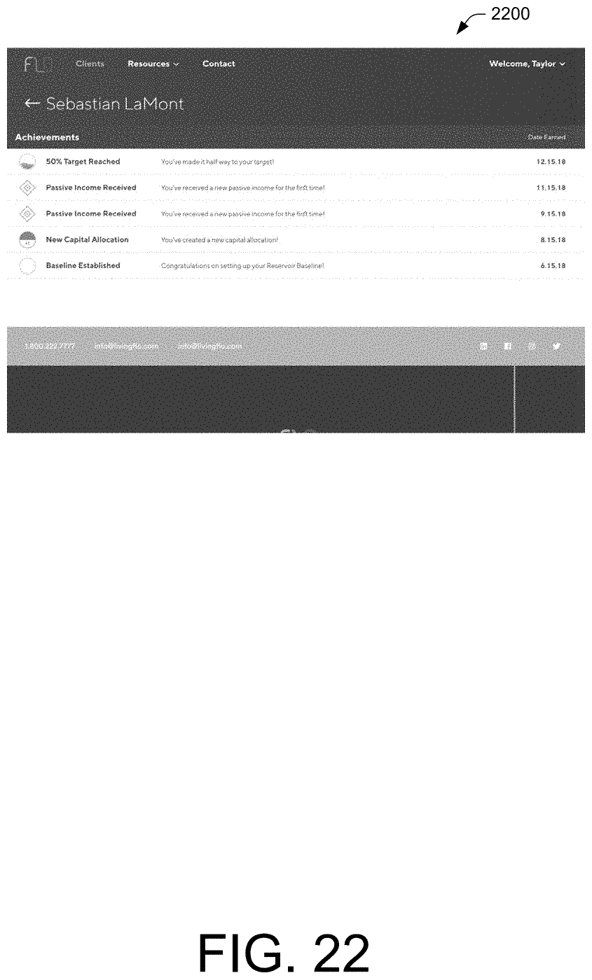

FIG. 22 is a schematic diagram of an illustrative user interface 2200 displayed on a financial advisor system 130 showing financial achievements of the user 104 of FIG. 19, according to examples of the disclosure. The achievements can indicate benchmarks and/or targets associated with the user's financial goals. The achievements can be displayed for a particular time period, but the time period over which financial data for the user 104 is displayed can be changed by the financial adviser 132, and responsive to such change, the financial advisor system 130 and the FLO service system(s) 110 can cooperate to provide the financial data and/or metrics requested by the financial advisor 132.

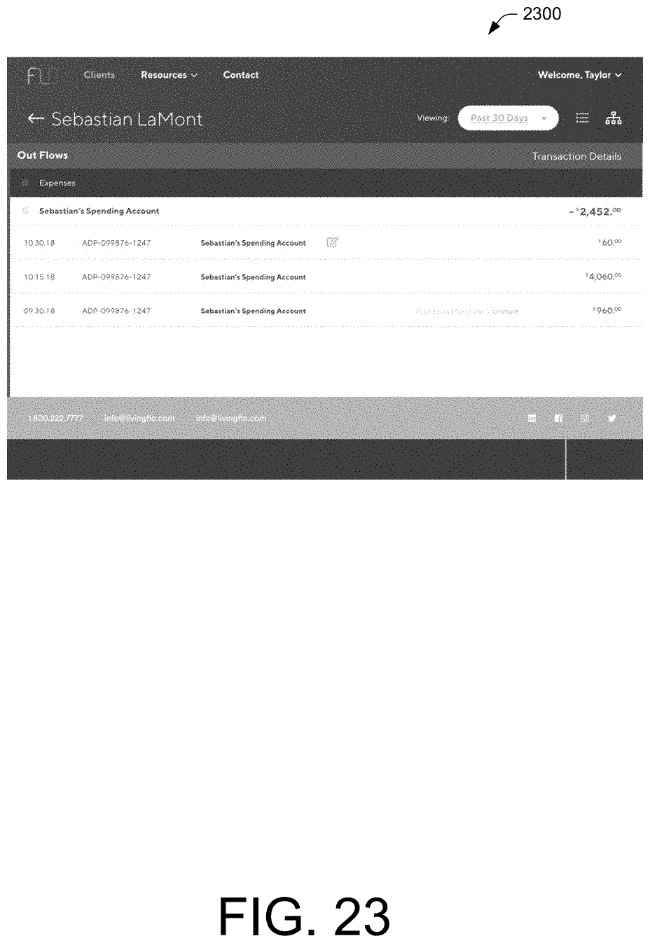

FIG. 23 is a schematic diagram of an illustrative user interface 2300 displayed on a financial advisor system 130 showing financial outflows of the user 104 of FIG. 19, according to examples of the disclosure. As shown, various destinations of the user's money can be viewed by the financial advisor 132. The financial advisor 132 can be able to provide advice based at least in part on the user's outflow information, such as by sending a message 138 to the user 104 via his or her financial advisor system 130. Again, the time period over which financial data for the user 104 is displayed can be changed by the financial adviser 132, and responsive to such change, the financial advisor system 130 and the FLO service system(s) 110 can cooperate to provide the financial data and/or metrics requested by the financial advisor 132.

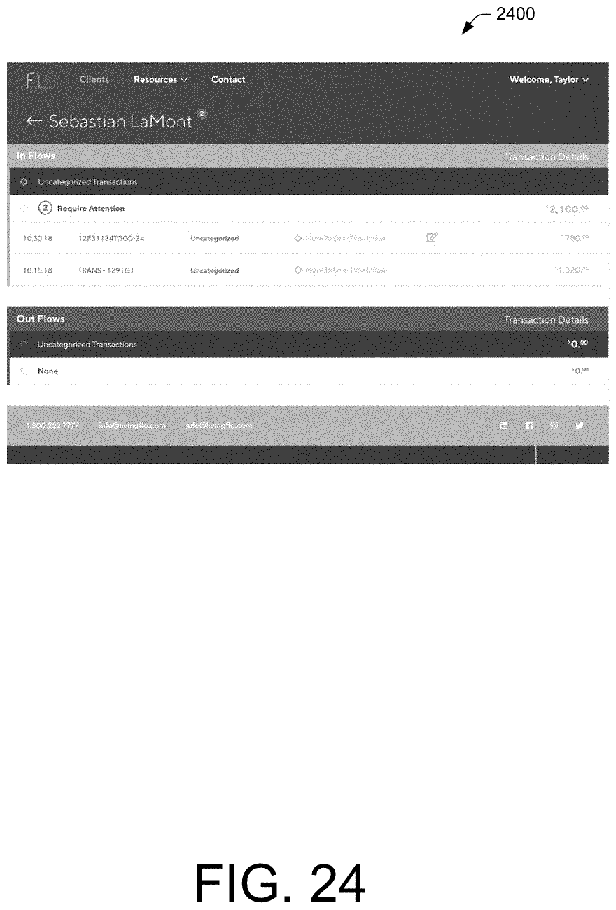

FIG. 24 is a schematic diagram of an illustrative user interface 2400 displayed on a financial advisor system 130 showing uncategorized financial transactions of the user of FIG. 19, according to examples of the disclosure. These uncategorized transactions can be inflows, outflows, or any other suitable transaction. The financial advisor can be able to select one or more of the uncategorized transactions and ascribe the selected transaction to a category. Thus, this user interface 2400 can enable the financial advisor to see which transaction of the user 104 is left uncategorized over a particular time period, so that those transactions can be assigned to an appropriate category. The time period over which uncategorized transactions for the user 104 is displayed can be changed by the financial adviser 132, and responsive to such change, the financial advisor system 130 and the FLO service system(s) 110 can cooperate to provide the indications of uncategorized transactions requested by the financial advisor 132.

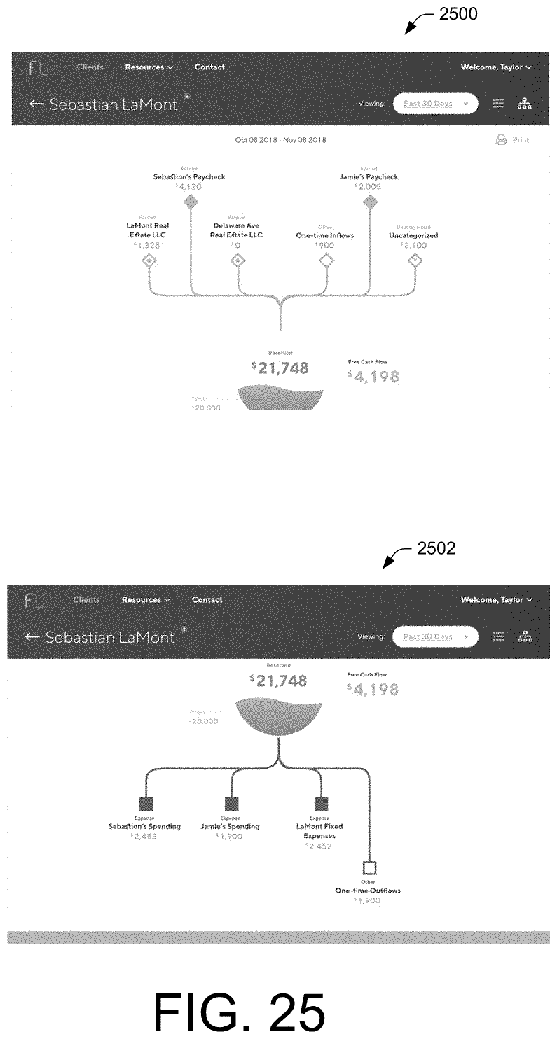

FIG. 25 is a schematic diagram of an illustrative user interface 2500, 2502 displayed on a financial advisor system showing graphical display of financial outflows and financial inflows of the user of FIG. 19, according to examples of the disclosure. The full chart can be viewed by scrolling the user interface 2500, 2502. The summation of the inflows and subtraction of the outflows can provide a free cash flow amount over a particular time period. The reservoir value can also be displayed on this user interface 2500, 2502. The time period over which the cash flows are displayed for the user 104 can be changed by the financial adviser 132, and responsive to such change, the financial advisor system 130 and the FLO service system(s) 110 can cooperate to provide the indications of uncategorized transactions requested by the financial advisor 132.

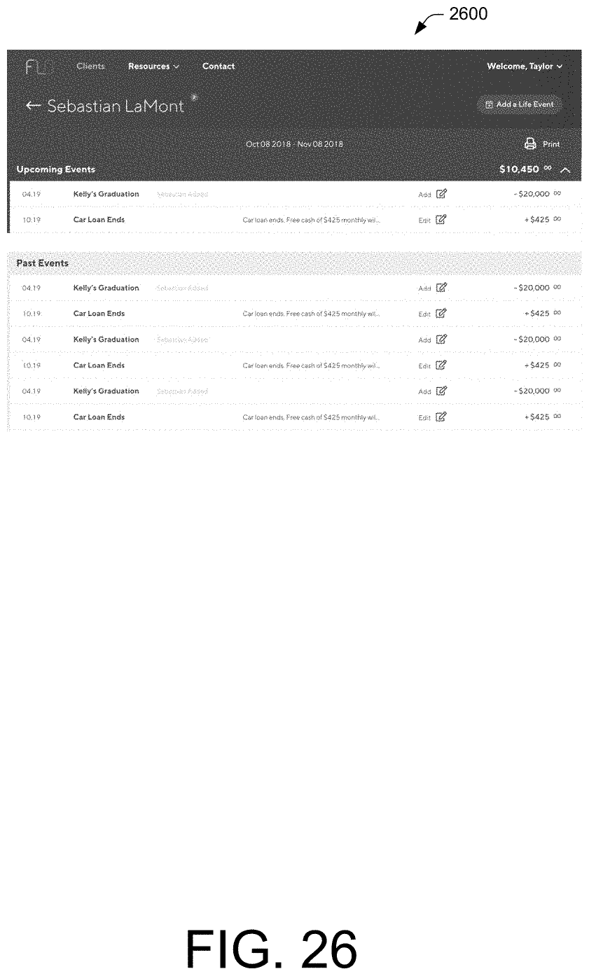

FIG. 26 is a schematic diagram of an illustrative user interface 2600 displayed on a financial advisor system 130 showing financial events associated with the user 104 of FIG. 19, according to examples of the disclosure. These financial events can include past events and/or upcoming events. The financial advisor 132 can be able to view these financial events and make financial recommendations to the user 104.

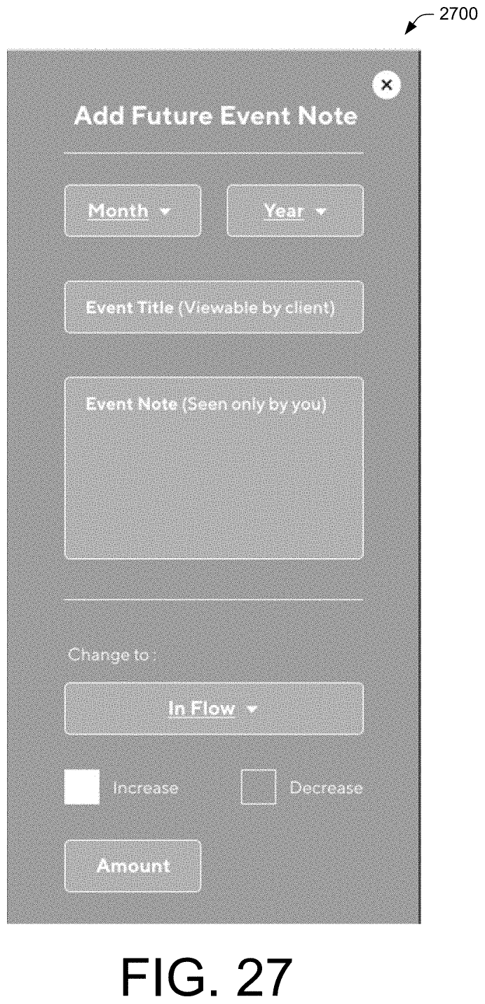

FIG. 27 is a schematic diagram of an illustrative user interface 2700 displayed on a financial advisor system 130 for indicating a future event note of the user 104 of FIG. 19, according to examples of the disclosure. The financial advisor can be able to add a date when the note is to be effective, along with a title, and the note itself. The financial advisor 132 can further be able to classify the event, such as by designating the type of cashflow that it is.

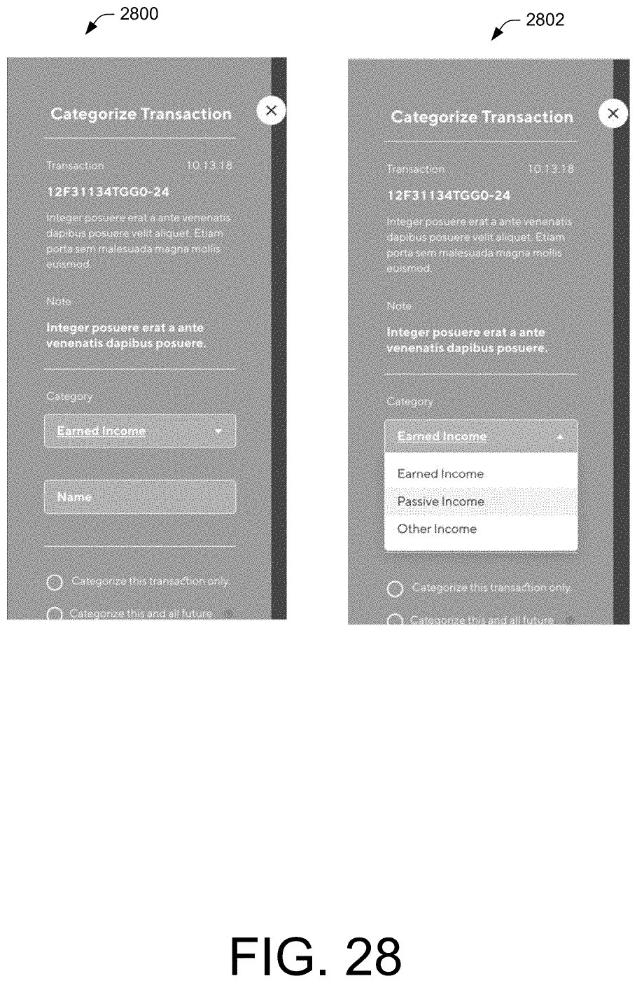

FIG. 28 is a schematic diagram of illustrative user interfaces 2800, 2802 displayed on a financial advisor system 130 for categorizing a financial transaction of the user 104 of FIG. 19, according to examples of the disclosure. The categorization can involve the financial advisor 132 assigning one or more descriptors to the financial transaction to be categorize. Once categorized, the financial transaction can be used in displaying financial transactions and/or in the use of calculating financial metrics for the user 104.

Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts, and media are disclosed as example forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes can be made to the subject matter described herein without following the example configurations and applications illustrated and described, and without departing from the true spirit and scope of the present invention, which is set forth in the following claims.

What is claimed is:

1. A system comprising:
one or more processors; and
memory to store computer-executable instructions that, when executed by the one or more processors, cause the system to perform acts to:
receive, from a financial advisor system associated with a financial advisor, financial advisor profile information about a financial advisor profile of the financial advisor;
authenticate, based at least in part on the financial advisor information, the financial advisor profile;
determine, based at least in part on the financial advisor profile, a plurality of users associated with the financial advisor profile;
determine financial data associated with at least one of the plurality of the users, wherein the financial data is associated with a first time period; and
send the financial data to the financial advisor system.

2. The system as recited in claim 1, wherein the computer-executable instructions, when executed by the one or more processors, cause the system to further perform acts to:
receive an indication that a particular user among the plurality of users permits sharing financial data with the financial advisor, wherein to send the financial data to the financial advisor system is based at least in part on the indication that the particular user permits sharing financial data with the financial advisor.

3. The system as recited in claim 2, wherein the computer-executable instructions, when executed by the one or more processors, cause the system to further perform acts to:
determine, based at least in part on the financial data associated with the one or more users, a financial metric associated with at least one of the one or more users; and
send, to a financial advisor system, an indication of the financial metric.

4. The system as recited in claim 3, wherein the financial metric is based at least in part on at least one of financial inflows or financial outflows associated with a particular user of the plurality of users.

5. The system as recited in claim 1, wherein the computer-executable instructions, when executed by the one or more processors, cause the system to further perform acts to:
receive an indication of selection by the financial advisor of a second time period;
determine second financial data associated with the at least one of the plurality of the users, wherein the financial data is associated with the second time period; and
send the second financial data to the financial advisor system.

6. A method comprising:
receiving, via a user interface, user input indicating financial advisor profile information associated with a financial advisor profile;
sending, to a service system, the financial advisor profile information;
receiving, from the service system, an indication of one or more users associated with the financial advisor profile;
receiving, from the service system, first financial data associated with the one or more users;
displaying, on a display screen, the first financial data from a plurality of financial data associated with the one or more users;
receiving an indication of a selection of a first user of the one or more users; and
requesting, from the service system and based at least in part on the selection, second financial data associated with the first user; and
displaying, on the user display, the second financial data.

7. The method as recited in claim 6, wherein the financial metric value is at least one of: (i) a free cash flow during the time period; (ii) an aggregate reservoir value at an end of the time period; (iii) a FLO score during the time period; (iv) a FLO score rating during the time period; (v) a moving average based at least in part on the FLO score during the time period; or (vi) a standard deviation based at least in part on the FLO score during the time period.

8. The method as recited in claim 6, wherein displaying the second financial data further comprises:
displaying a chart showing one or more outflow transactions associated with the first user and one or more inflow transactions associated with the first user.

9. The method as recited in claim 6, further comprising:
receiving an indication of a selection of a time period;
requesting, from the FLO service system, third financial data associated with the first user from the time period; and
receiving, from the FLO service system, the third financial data; and
displaying the third financial data.

10. The method as recited in claim 10, wherein the first user indicated association with the financial advisor.

11. The method as recited in claim 6, further comprises:
receiving an indication of a selection of a second user of the one or more users;
sending, to the FLO service system, a request for third financial data associated with the second user; and
receiving, from the FLO service system, the third financial data associated with the second user.

12. A system comprising:
one or more processors; and
memory to store computer-executable instructions that, when executed by the one or more processors, cause the system to perform acts to:
receive, via a user interface, user input indicating financial advisor profile information associated with a financial advisor profile;
send, to a service system, the financial advisor profile information;
receiving, from the service system, an indication of one or more users associated with the financial advisor profile;
receive, from the service system, first financial data associated with the one or more users;
display, on a display screen, the first financial data from a plurality of financial data associated with the one or more users;
receive an indication of a selection of a first user of the one or more users; and
request, from the service system and based at least in part on the selection, second financial data associated with the first user; and
display, on the user display, the second financial data.

13. The system as recited in claim 12, wherein the financial metric value is at least one of: (i) a free cash flow during the time period; (ii) an aggregate reservoir value at an end of the time period; (iii) a FLO score during the time period; (iv) a FLO score rating during the time period; (v) a moving average based at least in part on the FLO score during the time period; or (vi) a standard deviation based at least in part on the FLO score during the time period.

14. The system as recited in claim 12, wherein to display the second financial data further comprises acts to:
display a chart showing one or more outflow transactions associated with the first user and one or more inflow transactions associated with the first user.

15. The system as recited in claim 12, wherein the computer-executable instructions, when executed by the one or more processors, cause the system to perform further acts to:
receive an indication of a selection of a time period;
request, from the FLO service system, third financial data associated with the first user from the time period; and
receive, from the FLO service system, the third financial data; and
display the third financial data.

16. The system as recited in claim 15, wherein the first user indicated association with the financial advisor.

17. The method as recited in claim 12, further comprises:
receive an indication of a selection of a second user of the one or more users;
send, to the FLO service system, a request for third financial data associated with the second user; and
receive, from the FLO service system, the third financial data associated with the second user.
